(19) United States
(12) Patent Application Publication
(10) Pub. No.: US 2003/0083922 A1
(43) Pub. Date: May 1, 2003

(54) Systems and methods for managing critical interactions between an organization and customers

(76) Inventor: Wendy Reed, Alpharetta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/229,613

(22) Filed: Aug. 28, 2002

Related U.S. Application Data
(60) Provisional application No. 60/315,921, filed on Aug. 29, 2001.
(60) Provisional application No. 60/358,194, filed on Feb. 20, 2002.

(51) Int. Cl. G06F 17/60

(52) U.S. Cl. 705/9

(57) ABSTRACT

Systems and methods for managing interactions between an organization and a customer. An associated system for managing a customer relationship via a network includes a discovery map tool program module with a discovery map engine and a database engine. The discovery map engine is in communication with the network. The discovery map engine is adapted to receive team information associated with the vendor and the customer; receive issue information associated with the customer; and receive solution information associated with the vendor. The database engine in communication with the discovery map tool program module, the database engine is adapted to store the team information, issue information, and solution information. The discovery map engine is further adapted to generate a visual map incorporating the team information, issue information, and solution information; initiate an on-line, real time collaboration session between the vendor and customer; and confirm the team information, issue information, and solution information with the customer.

### RELATED APPLICATIONS

This application claims priority to U.S. Provisional patent application No. 60/315,921, filed Aug. 29, 2001; and to U.S. Provisional patent application No. 60/358,194, filed Feb. 20, 2002; which are both incorporated in their entirety by reference.

### FIELD OF THE INVENTION

The invention is generally related to data management systems, and more particularly related to systems and methods for managing interactions between an organization and a customer.

### BACKGROUND OF THE INVENTION

Most organizations that are in the business of selling a product or a service to a customer must effectively manage interactions and relationships with the customer in order to sell the product or service. Opportunities to manage such interactions and relationships with the customer can extend from the initial sales call, to managing the ongoing relationship once a sale is complete. For an organization that is in the business of selling products or services there has been no substitute for a face-to-face meeting with the customer. A face-to-face meeting has been an effective way for a salesperson to understand what his customer needed, and further, an effective way for a salesperson to sell his organization's products and services that meet the customer's needs. In some instances, these interactions and relationships will be critical for a salesperson, organization, or a customer to understand, utilize, and implement. Therefore, a need exists for systems and methods to manage critical interactions and relationships between an organization and a customer.

With the advent of the Internet and other communication means, it has become relatively easier for people and business entities to share information and to communicate with each other. An electronic document created in one part of the world can be electronically transmitted via the Internet to another part of the world in a relatively short time. With improvements in Internet browser technology and high speed telecommunications technology, such as optical fiber networks, it has become relatively attractive for organizations and personnel to access the Internet and to browse or download information posted on the various websites. Such improvements have led to the creation of conventional software tools that enable people to meet in “cyberspace” or online via the Internet instead of a face-to-face in a personal meeting. Thus, personnel associated with organizations and other entities could share and review electronic documents together online without the need to meet physically or face-to-face.

Sales organizations for businesses which rely heavily on the aspect of meeting people face-to-face began to look at the use of such conventional software tools. By meeting customers online via the Internet, sales organizations could save time and costs without having to travel to meet face-to-face with the customers. Organizations could also streamline some interactions with customers and engage in relatively effective communications.

Many conventional software tools to interact with customers online currently exist. These conventional tools can be used by a salesperson to electronically meet and exchange information with a customer instead of having to meet with the customer face-to-face. While such tools have the potential to create a relatively effective interaction with a customer by enabling the salesperson to understand the customer's problems, by documenting the needs of the customer rising from such problems, and by suggesting a solution from a list of products and services that the salesperson's organization has to offer, there still remain significant drawbacks to using these conventional software tools.

These conventional software tools offer a relatively broad range of capabilities, such as conducting an electronic meeting. For example, conventional software tools include electronic meeting application packages such as Web-Ex, Netmeeting, and Placeware. These conventional software tools allow persons to share documents and information via the Internet through an Internet website. They also allow persons to remotely demonstrate a software application online via the Internet while other persons, such as a customer, can remotely view how the person is using the software. A new term called “collaborative software” has been coined in the art to describe such conventional software tools. However, these conventional software tools lack a specifically designed and formatted application to address the needs of a sales organization implementing the software for a customer. Furthermore, these conventional software tools lack the ability to facilitate the collection and exchange of customer information tailored to assist in the sale of a sales organization's business products and services.

At the other end of the spectrum are conventional software tools known generally as “Customer Relations Management” (CRM) software applications. These types of conventional software tools are designed to share customer information only within the “four walls” of a sales organization or vendor. These conventional software tools may be relatively effective in tracking customer information to be shared within a vendor's own organization, but lack the specific capacity to share information with a customer. Moreover, these conventional software tools do not have the capability to allow the salesperson to actively collaborate with a customer to determine what the customer actually needs. Furthermore, these conventional software tools also lack the capability to limit access to potentially critical or proprietary data that is sometimes only meant for viewing by employees or insiders of the salespersons or vendor's own organization. These and other drawbacks contribute to the lack of an effective real-time, online collaboration between a sales organization and its customers.

Other drawbacks and needs exist.

### SUMMARY OF THE INVENTION

Systems and methods in accordance with various embodiments of the invention provide a software tool for managing interactions between an organization and a customer. Such systems and methods allow a salesperson to collaborate with a customer to collect and format the customer information in such a way so as to specifically identify a customer's needs. Finally, such systems and methods provide on-line and real-time collaboration between personnel associated with a vendor and its customers. Collection and organization of information during a collaborative session addresses needs of the vendor's sales organization as well. The vendor's sales organization will be able to manage its relationship with its customers by obtaining the information. Furthermore, a collaborative session enlists the customer's help to more specifically prioritize and identify their needs or problems. That in turn helps a salesperson to more effectively address the needs of the customer by offering solutions available through the vendor's products and services.

Systems and methods in accordance with various embodiments of the invention focus on a suite of software tools for managing interactions between an organization and its customers. In one aspect of the invention, systems and methods in accordance with various embodiments of the invention provide a software application program that embodies a unique series of methodologies designed specifically to allow sales and services personnel to gather key business requirements from potential and existing customers. This information is then used to position the vendor's products and services in a way that gains favorable customer mindshare.

One such tool is a discovery map tool program module which collects information and creates a visual map of the vendor's interactions with a customer to assist the vendor's understanding of the customer's needs. The visual map can in-turn be used to assist a salesperson in selling the vendor's products or services to specifically meet the customer's needs. Another aspect of the discovery map tool program module facilitates an active and real-time collaboration between the customer and the vendor, such as the vendor's salesperson. By sharing a visual map of one or more relationships and issues identified in a tree data structure, or in a flow chart representation of the tree data information, a vendor and customer can confirm their understanding of each other's needs.

One aspect of systems and methods according to various embodiments of the invention focuses upon a method for managing interactions between a vendor and a customer. The method includes receiving team information associated with the vendor and the customer; receiving issue information associated with the customer; and receiving solution information associated with the vendor. The method further includes generating a visual map incorporating the team information, issue information, and solution information; initiating an on-line, real time collaboration session between the vendor and the customer; and confirming the team information, issue information, and solution information with the customer.

Another aspect of systems and methods according to various embodiments in accordance with the invention provides a system for managing a customer relationship via a network. The system includes a discovery map tool program module with a discovery map engine and a database engine. The discovery map engine is in communication with the network. The discovery map engine is adapted to receive team information associated with the vendor and the customer; receive issue information associated with the customer; and receive solution information associated with the vendor. The database engine in communication with the discovery map tool program module, the database engine is adapted to store the team information, issue information, and solution information. The discovery map engine is further adapted to generate a visual map incorporating the team information, issue information, and solution information; initiate an on-line, real time collaboration session between the vendor and the customer; and confirm the team information, issue information, and solution information with the customer.

Objects, features and advantages of various systems and methods according to various embodiments of the invention include:

(1) providing the ability to manage interactions between a vendor and its customers;

(2) providing the ability to determine a customer's business-related needs;

(3) providing the ability to generate a visual map of an issue information and solution information; and

(4) providing the ability to facilitate an online and real-time coloration session between a vendor and a customer.

Other objects, features and advantages of various aspects and embodiments of systems and methods according to the invention are apparent from the other parts of this document.

### BRIEF DESCRIPTION OF DRAWINGS FOR THE EMBODIMENTS

FIG. 1 is a functional block diagram of an exemplary environment for a system in accordance with various embodiments of the invention.

FIG. 2 is a functional block diagram of components of an exemplary discovery map tool program module in accordance with various embodiments of the invention.

FIG. 3 is a flowchart for an exemplary method in accordance with various embodiments of the invention.

FIG. 4 is a flowchart for a subroutine of the method shown in FIG. 3.

FIG. 5 is a flowchart for another subroutine of the method shown in FIG. 3.

FIGS. 6-25 illustrate a sequence of webpages associated with the system, method, and subroutines shown in FIGS. 1-5.

### DETAILED DESCRIPTION OF EMBODIMENTS OF THE INVENTION

Systems and methods in accordance with various embodiments of the invention provide a software tool for managing interactions between an organization and a customer. Such systems and methods allow a salesperson to collaborate with a customer to collect and format the customer information in such a way so as to specifically identify a customer's needs. Furthermore, such systems and methods offer capabilities that fall between the spectrum of capabilities described above. Finally, such systems and methods combine and accentuate the capabilities of the collaborative by allowing active and real-time collaboration with both the customers and people within the vendor's own organizations. Collection and organization of the data during the collaborative session addresses the needs of a sales organization. An associated sales organization will be able to collect customer information necessary for them to better manage their relationship. Collaborative sessions will enlist the customer's help to more specifically prioritize and identify their needs or problems. That in turn helps a sales person to more effectively address the needs of the customer by offering solutions available through their products and services.

The term “KBR” is defined as a key business requirement. A key business requirement is an action that an organization must achieve or perform to accomplish its organizational goals. Generally, business requirements can exist at various levels of an organization. At lower levels of the organization, business requirements become more tactical and specific. Whereas, at higher levels of the organization, business requirements become more strategic and overarching. Thus, a key business requirement is at the highest level of the organization at which the decision to select a solution is made.

The term “TP” is defined as a tactical pain. A tactical pain is a situation, task, or process that is not working well and prevents or otherwise hinders the achievement of a key business requirement.

The term “CP” is defined as a consequential pain. A consequential pain is a consequence or impact of not resolving a tactical pain or problem. A consequential pain is a key management issue that can drive a buying or purchasing decision. Consequential pains can be further classified as strategic, financial, internal, or political. A strategic consequential pain prevents or otherwise hinders a customer from gaining strategic or a competitive advantage in the marketplace, such as eroding market share, slow time to market, inability to expand globally, constricting government regulation, etc. A financial consequential pain significantly degrades a customer's profitability or financial performance, i.e. poor cash flow, increasing costs, slow return on investment (ROI), eroding profitability, plummeting stock value, etc. An internal consequential pain is reflected in non-optimal employee behavior such as those that result from a highly charged emotional situation. Such behavior is characterized by lack of innovation or empowerment, a need for business process reengineering, poor quality, etc. Finally, a political consequential pain is related to an influential person. Such persons can affect or participate in the decisionmaking involved prior to addressing business requirements.

The term “vendor” is defined as an organization or persons associated with sales or service personnel. In general, the vendor sales or service personnel are offering to sell a product or service to a customer.

The term “customer” is defined as an organization or persons associated with a prospective, current, or past purchaser or consumer of products, services, or offerings offered for sale by a vendor.

The term “issue” is defined as a problem for a customer's organization, operations, or other business-related circumstance.

The term “solution” is defined as a possible resolution of an issue, including but not limited to, a vendor's product, service or offering.

The term “visual map” is defined as a tree-data structure, flowchart, or other graphical representation of team information, issue information, and solution information.

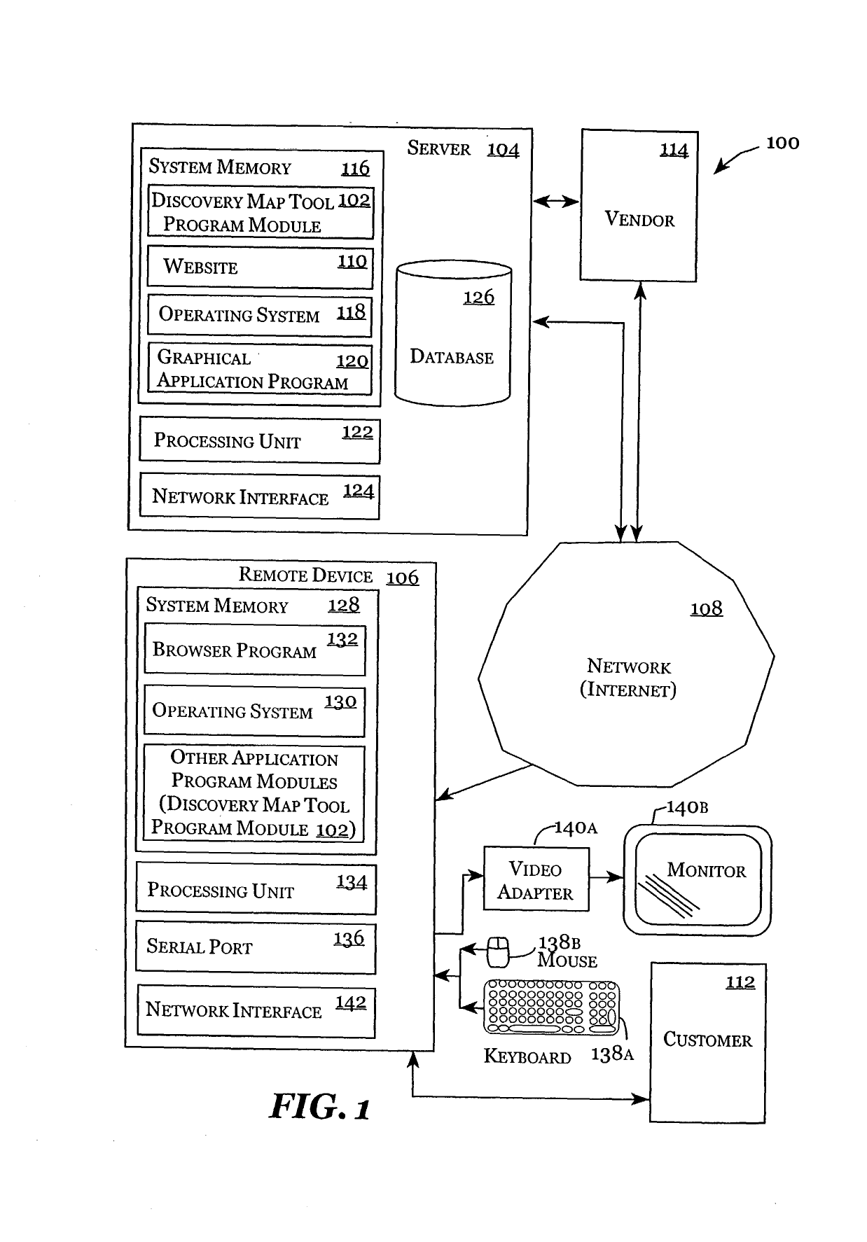

Particular embodiments of the invention will now be described in greater detail with reference to the drawings. FIG. 1 illustrates a preferred environment 100 for a system in accordance with various embodiments of the invention. In this embodiment, the invention includes a discovery map tool program module 102. Typically, a discovery map tool program module 102 is set of computer-executable instructions that is configured to operate on a server 104 within a distributed network environment 100. The discovery map tool program module 102 may be configured for execution by a server 104 that is accessible by a remote device 106 via a distributed computer network 108, such as the Internet. Moreover, a discovery map tool program module 102 can comprise a website 110 for interacting with one or more users, such as a customer 112 or a vendor 114, via a network 108 such as the Internet.

Generally, a discovery map tool program module 102 comprises computer-executable instructions adapted for receiving information from a vendor and/or customer, generating a visual map for display, and initiating a collaboration session between a vendor and a customer.

The server 104 may comprise a conventional computer system configured to function as a network server. For example, server 104 may comprise a memory 116 for storing an operating system 118, one or more discovery map tool program modules 102, a graphics application program 120, as well as other program modules and data files. The server 104 may further comprise a processing unit 122 and a network interface 124. The server 104 may also comprise or be in communication with an associated database 126 for storing data relating to the discovery map tool program module 102 or any other program module. As will be apparent to those of skill in the art, a server 104 may comprise additional features and components.

A remote device 106 may comprise a desktop computer, a laptop computer, a hand-held device, a personal digital assistant, a kiosk, or the like. In general, a remote device 106 may comprise a memory 128 for storing such things as an operating system 130, a browser program 132 or other program modules or data files, and a processing unit 134 for executing application programs, such as the browser program 132. The remote device 106 may also comprise a serial port 136 for communication with one or more input devices such as a keyboard 138a, a mouse 138b; for communication with associated video output devices such as a video adapter 140a and a display device or monitor 140b; and for communication with a distributed computer network 108 via a network interface 142 or a dedicated communications link. The input device 138a-b may be connected to the remote device 106 or may be connected to the network 108. As will be apparent to those of skill in the art, a remote device 106 may comprise additional features and components.

A remote device 106 may be configured for execution of a browser program 132 in order to view the website 110 and interact with the discovery map tool program module 102 at the server 104. The remote device 106 may communicate with the server 104 via any well-known communications link, such as a local area network, a wide area network, the Internet, etc. For example, the communications link, or at least a portion thereof, may be a wireless network.

In some instances, the remote device 106 may be configured for executing one or more discovery map tool program modules 102. Alternatively, the remote device 106 can communicate with a server 104 or server computer, which executes the one or more discovery map tool program modules 102. In other instances, both the remote device 106 and the server 104 may execute one or more discovery map tool program modules 102.

One or more remote devices 106 may simultaneously communicate with the discovery map tool program module 102 via the network 108. For example, during a collaboration session with the discovery map tool program module 102, vendor personnel communicating via one more remote devices 106 may simultaneously communicate with customer personnel operating other remote devices 106. The discovery map tool program module 102 facilitates this type of communication on-line and in real time.

In at least one exemplary embodiment, the invention can be based on an Application Service Provider (ASP) model with a discovery map tool program module 102 or an associated application residing at a location predetermined by or otherwise selected by a host or other entity. The discovery map tool program module 102 can provide or otherwise be associated with an Internet website in communication with a network such as the Internet. The host can provide a “link” on a host Internet website that when selected by a user such as a customer will connect to a “Log On” webpage of the Internet website associated with the discovery map tool program module 102 or other associated application. In addition, each user or customer can have a distinct address or Universal Resource Link (URL) for one or more employees associated with the user or customer to use that when selected links to the “Log On” webpage of the Internet website associated with the discovery map tool program module 102 or other associated application.

In another exemplary embodiment of the invention, methods and processes based upon Active Server Pages, VBScript, and/or JavaScript can be utilized. For example, a discovery map tool program module 102 or associated application can be built on a SQL Server 7.0 database and several associated components. Interaction of a user with the discovery map tool program module 102 or associated application is performed through Microsoft's Active Sever Page technology. Associated data collected by or otherwise received by the discovery map tool program module 102 is stored in a database such as a Structured Query Language (SQL) Server database with the exception of discovery map tool-provided images, such as GIF files, which can be stored separately in a directory on a host server. Microsoft SQL Server 7.0 stores any collected data and any requisite templates. Discovery map tool-provided images can be created with a graphics application program which can create discovery map tool-type images, such as Microsoft's Visio 2000 Standard Edition. Additional logic to convert the information can be provided by a user during input of information to an “Issues” portion of the application, which can be used to create the flow chart visual representation of the data. Finally, to generate and distribute e-mail reminders of tasks the system uses Jmail or another similar type e-mail or messaging service. Those skilled in the art will recognize that other technologies, hardware, and software can be utilized to implement the system and method according to various embodiments of the invention.

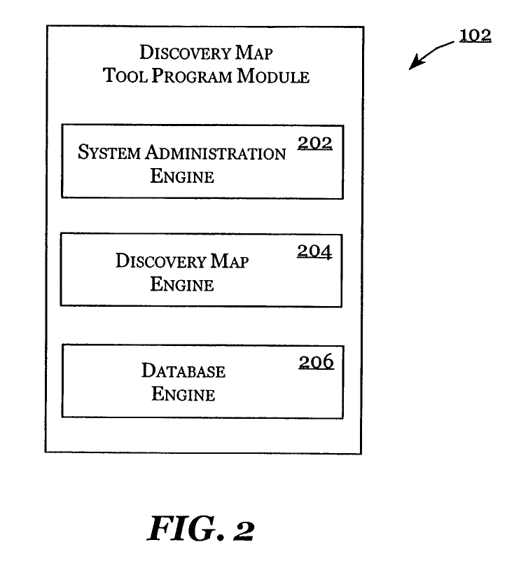

FIG. 2 illustrates components of an exemplary discovery map tool program module of FIG. 1 in accordance with the invention. The discovery map tool program module 102 includes a system administration engine 200, a database engine 202, and a discovery map engine 204. Other engines or components for a discovery map tool program module 102 in accordance with various embodiments of the invention can exist.

The system administration engine 200 is configured for providing selective user access to administrative features or functionality of the discovery map tool program module 102 or an associated website. Furthermore, the system administration engine 200 is adapted to track user access to various functions provided by the discovery map tool program module 102.

The database engine 202 is configured for storing user data input to the discovery map tool program module 102. A database 126 in communication with the database engine 202 provides data storage for user data input that can be accessed when needed.

The discovery map engine 204 is configured for generating a visual map based on user data input. An associated drawing or graphics application program, such as a Microsoft Visio Standard 2000, can be accessed by or work in conjunction with the discovery map engine 204 to provide drawing or graphics capability for the discovery map tool program module 102 when needed.

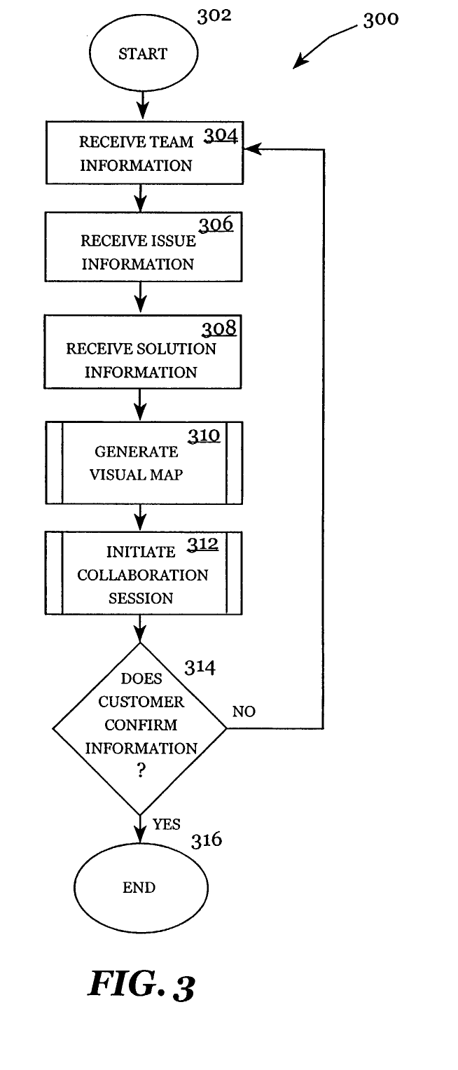

FIG. 3 illustrates a flowchart for an exemplary method in accordance with various embodiments of the invention. Generally, the method 300 is implemented by a software application program that embodies a unique series of methodologies to allow vendor sales and/or services personnel to gather sales-related customer information such as a potential customer's key business requirements. The method assists a user in collecting information from the vendor and the customer, and facilitates a discovery process that uncovers a potential or existing customer's needs and preferences. The method is adapted to generate a visual map to assist a user's understanding and management of critical interactions between an organization and customers. Moreover, the method is adapted to initiate a collaboration session between vendor personnel and customer personnel to confirm sales-related information and to make changes to information as needed.

The method 300 begins at 302.

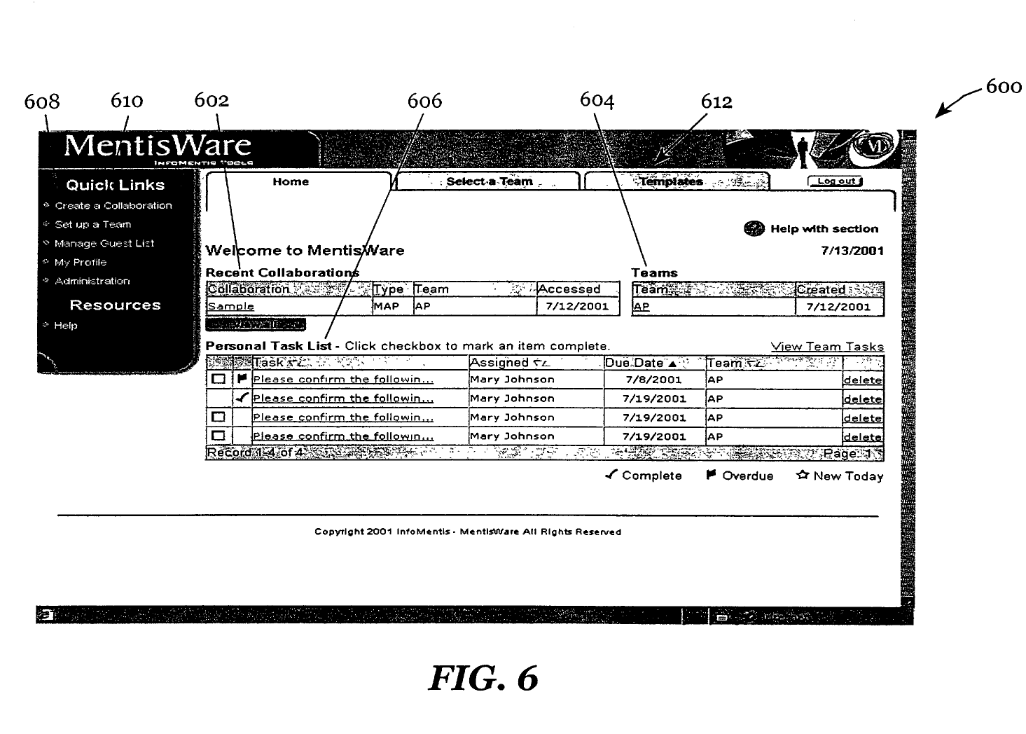

Team information is received at 304. Typically, a user inputs team information into one or more webpages provided by a discovery map tool program module 102. The webpages can be a series of webpages with queries to prompt a user to input information into one or more tabbed fields as illustrated in FIGS. 6-11. One or more users can input team information for one or more customer teams. The team information is received by the discovery map engine 204 and transmitted to the database engine 202 for processing and storage in a database 126.

A customer team is a group of one or more persons associated with a customer, each person having perceived responsibilities with respect to a particular task. Team information can include, but is not limited to, customer or prospect name, team name, individual names, individual roles, and individual attributes. For example, a user associated with a vendor can enter team information associated with a customer such as a prospect customer's name and responsibilities with respect to the prospect customer's business. In this example, the prospect customer may be the chief executive officer (CEO) of a business.

One or more users can input team information for one or more vendor sales teams. A vendor sales team is a group of one or more persons associated with a vendor, each person having perceived responsibilities with respect to a particular task. Team information can include, but is not limited to, vendor name, team name, individual names, individual roles, and individual attributes. By further example, a user associated with a vendor can enter team information associated with the vendor's own organization such as a sales team member and responsibilities with respect to the vendor's organization. 304 is, followed by 306, in which issue information is received. Typically, a user inputs issue information into one or more webpages provided by a discovery map tool program module 102. As issue information is input, the discovery map engine 204 transmits the information to the database engine 202 for processing and storage in a database 126.

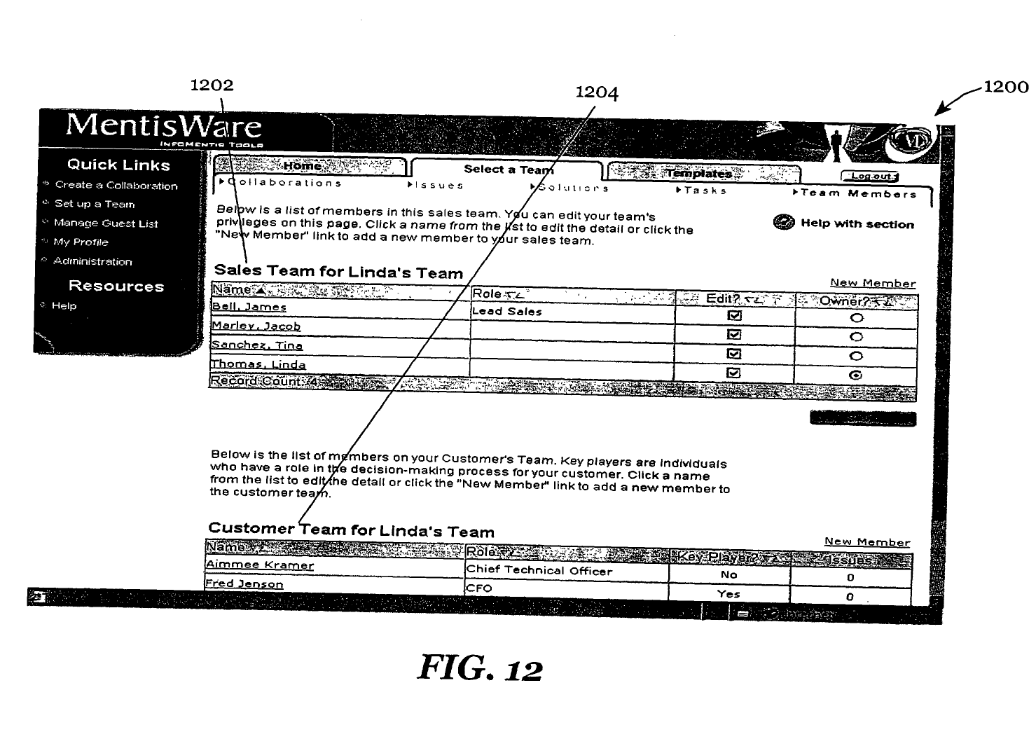

The webpages can be a series of webpages with queries to prompt a user to input information into one or more tabbed fields as illustrated in FIGS. 12-15. One or more users can input issue information for one or more customer teams. Issue information can include, but is not limited to, a subject associated with a customer, a type or characteristic of an issue, rating of an issue, a person involved with a specific issue, ownership of an issue, whether an issue is stated or assumed, confirmation of an issue, and a prioritization of a list of issues.

By way of example, a prospective customer such as a CEO of a business can be associated with one or more issues or problems that the CEO's business is experiencing. After communications with the CEO, a vendor could identify particular issues or problems that the CEO wants to address. The vendor could then rate particular issues with a rating scale of KBR (Key Business Requirement), TP (Tactical Pain), or CP (Consequential Pain) depending upon the perceived value of the issue to the prospect customer. Generally, a CEO will be an “owner” of KBR's, which are relatively important or strategic issues for a prospective company.

An issue can be designated as “stated” or “assumed.” If an issue is identified by a customer to the vendor, then the issue is considered to be “stated.” If an issue is identified by a vendor without specific input by a customer, then the issue is considered to be “assumed.”

Confirmation of an issue can be implemented by any communication means between a vendor and a customer. For example, an e-mail to an identified prospect, such as the CEO, can be generated by the discovery map tool program module 102 to confirm the existence of an identified issue for the customer's business and the prospect's involvement with the particular identified issue. In addition, the prospect can also provide a prioritization of a list of issues via the communication means. By prioritizing a list of issues that have been previously rated, a prospect provides additional issue information that can relate two or more different issues together.

One or more users can input issue information for one or more vendor sales teams. A vendor sales team is a group of one or more persons associated with a vendor, each person having perceived responsibilities with respect to a particular task. Issue information can include, but is not limited to, a subject associated with a customer, a type of issue, a rating of an issue, a person involved with a specific issue, ownership of an issue, confirmation of an issue, prioritization of a list of issues, or a characteristic of an issue.

After issue information is input by the user, the discovery map tool program module 102 can generate a task list for the user. A task list is a list of action items that the user should follow-up upon to obtain additional issue information. For example, if an issue is characterized as “assumed”, a task list item can be automatically generated for the user to confirm that a particular “assumed” issue is an actual issue for the customer. The task list item can be sent to the user via e-mail or displayed on a webpage showing the status of one or more task list items.

The user can also provide prioritization for a list of identified issues. Typically, the user is instructed to rank issues from highest to lowest priority, tending to be KBR's towards the higher end and other types of issues towards the lower end. In this manner, issues can be associated with each other or otherwise related.

In at least one embodiment, a selection of templates stored in the database 126 or in another data storage device can be provided by the discovery map tool program module 102 for user selection a related or similar type industry segment in which issues or problems specific to the industry segment have been previously encountered. A template specific to the telecommunications industry can be used with a customer associated with the telecommunications industry in order to provide previously identified issues for companies competing in or with the telecommunications industry. If a template is selected by the user, issue information from the template can be associated with a particular customer identified by the user, and issue information from the template can be modified as necessary to match issues identified by the customer.

Turning again to FIG. 3, solution information is received at 308. In general, a user inputs solution information into one or more webpages provided by a discovery map tool program module 102. Typically, the discovery map engine 204 receives the solution information and transmits the information to the database engine 202 for processing and storage in a database 126.

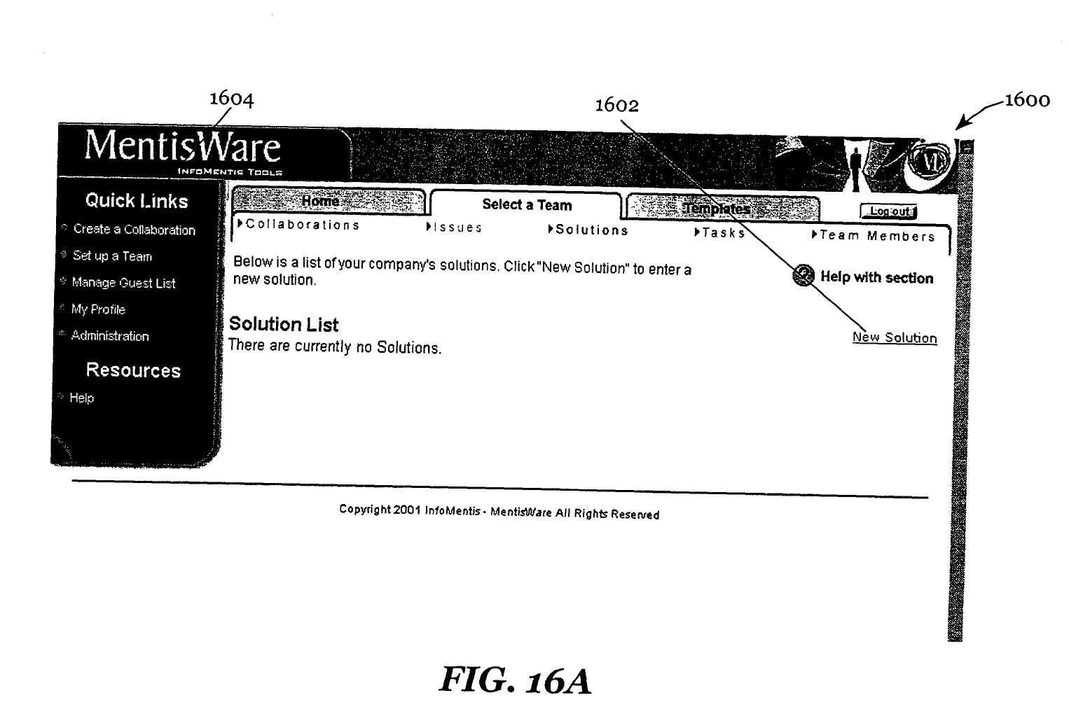

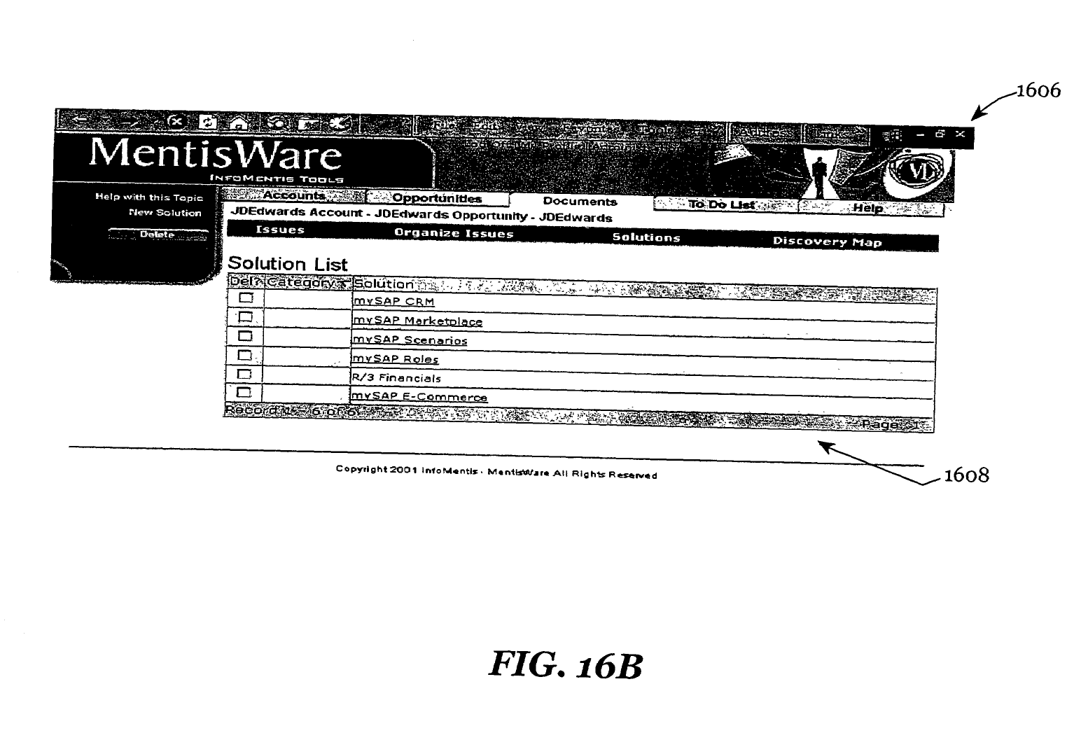

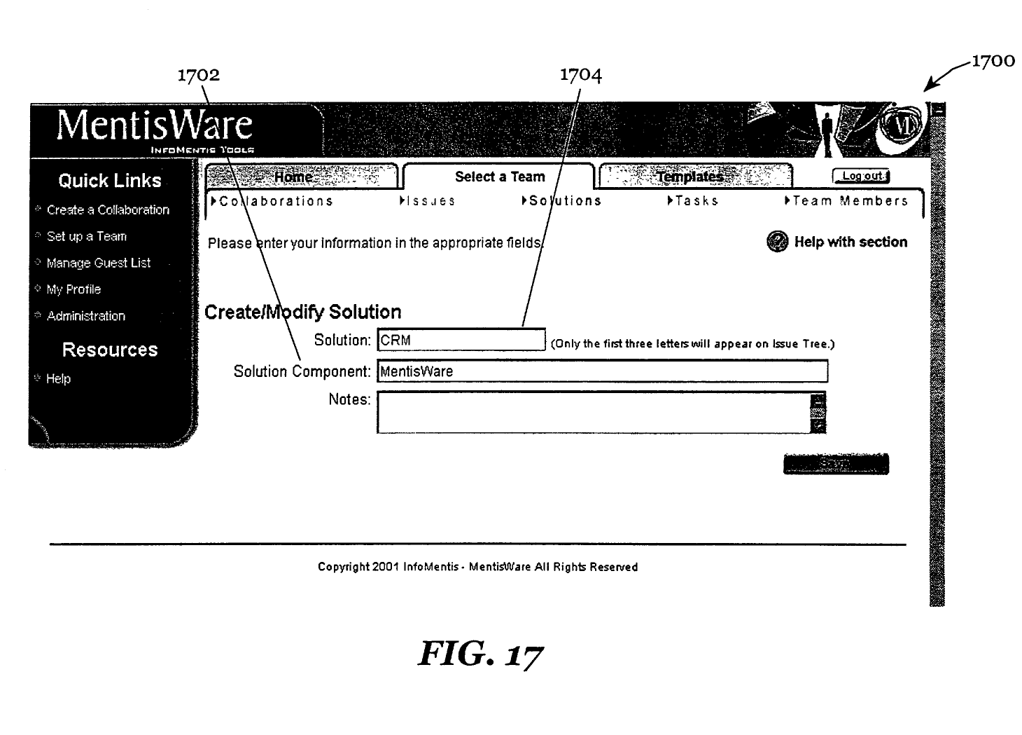

The webpage can be a series of webpages with queries to prompt a user to input information into one or more tabbed fields as illustrated in FIGS. 16-17. One or more users can input solution information for one or more customer teams. Solution information can include, but is not limited to, an action to address or otherwise solve a previously input issue, competitive information, and a solution component.

For example, a user associated with the vendor can identify particular solutions for an issue that may be offered by the vendor's business or organization. A particular solution can include a product, a service, and an offering provided by the vendor's business or organization. Furthermore, competitive information such as a solution provided by a third-party competitor of the vendor can also be identified. By recording and storing data on the capabilities, products and service offerings a vendor's competitors, a vendor salesperson can better position the vendor's own product or service vis-a-vis the vendor's competitors' offerings.

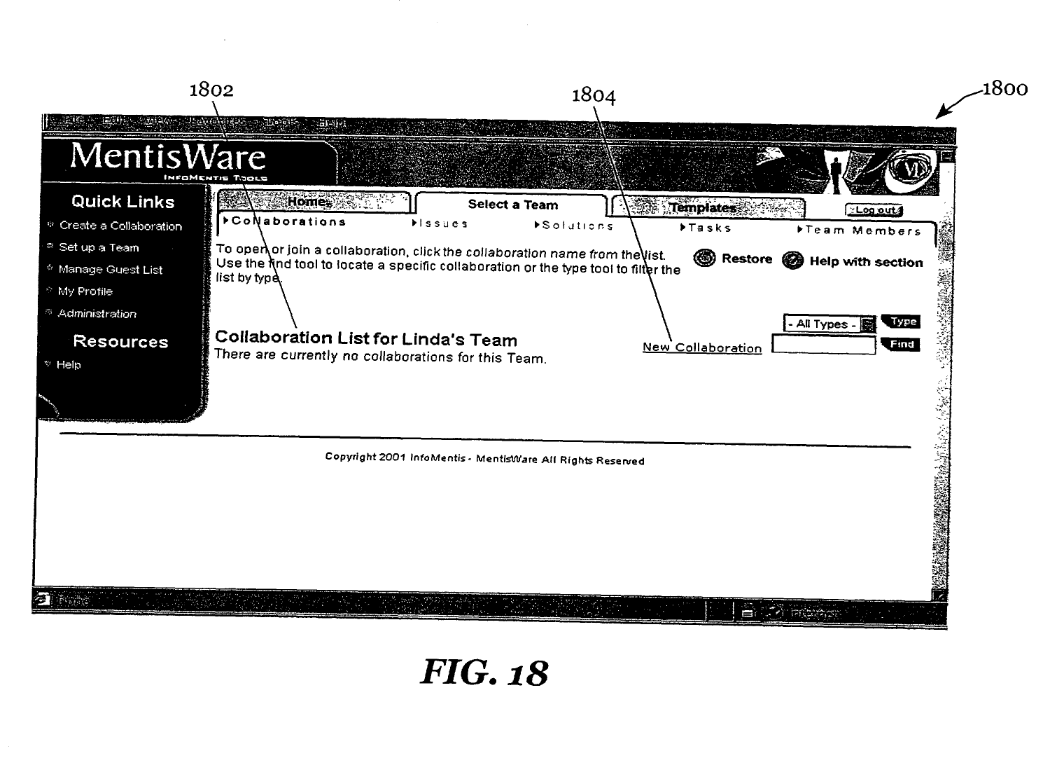

Next in subroutine 310, a visual map is generated. After team information, issue information, and solution information is received or otherwise collected by the discovery map tool program module 102, the discovery map engine 204 processes the information stored in the database 126, and generates a visual map using the team, issue, and solution information. As shown in FIGS. 18-23, a sequence of webpages can prompt the user to provide sufficient information to the discovery map tool program module 102 for generating a visual map. A visual map is generally an arrangement of team information, issue information, and solution information that can be shared between a vendor and a customer via a network. For example, a visual map can be an electronic document including an issue tree, a tree data structure, a discovery map, or a flowchart diagram. The visual map can display a hierarchy of tactical and consequential pains and their relationship to key business requirements of the potential or existing customer.

Display of a visual map or a visual representation of relatively important relationships and issues associated with the vendor and/or customer in a tree data-type structure or a flowchart representation assists a vendor and/or customer in organizing, retrieving, and utilizing previously stored data or other information. Utilizing a visual map structure to analyze the interactions between a vendor and a customer, leads to a relatively effective and easy to use analysis tool to develop or otherwise confirm a vendor's understanding of a particular customer's needs for the vendor's products and services.

Next in subroutine 312, a collaboration session is initiated with a customer. When a visual map has been generated, the discovery map tool program module 102 initiates a collaboration session with a customer associated with the team information. Typically, the discovery map engine 204 coordinates with the system administration engine 200 to communicate with multiple users via the network 108. A collaboration session is generally an on-line and realtime meeting via a network between a vendor and a customer including a simultaneous viewing of the visual map. During the collaboration session, the discovery map tool program module 102 can prompt a user such as customer personnel to confirm previously input team, issue, and solution information, and to make changes to previously input information as needed. The discovery map tool program module 102 provides a visual map accessible via the Internet for a vendor and customer to view on an associated display screen.

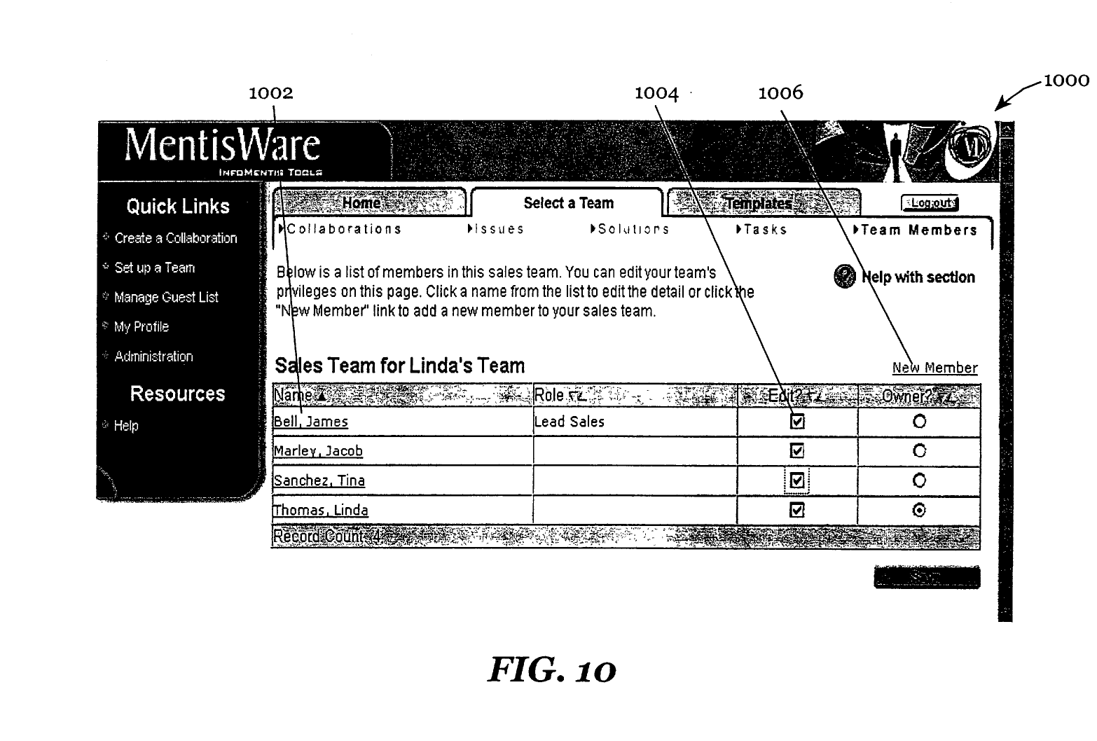

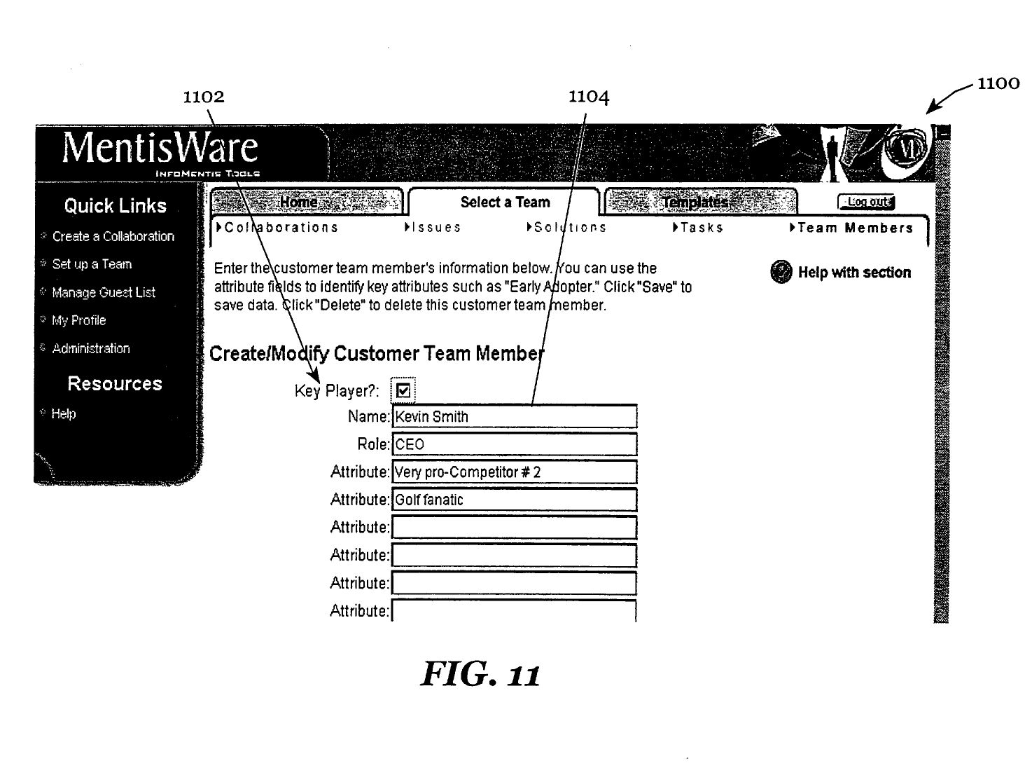

For example; a user can view a visual map and associated information on one or more webpages provided by a discovery map tool program module 102. The webpages can be a series of webpages with queries to prompt a user to confirm and/or change previously input information displayed in one or more tabbed fields as illustrated in FIGS. 10-11.

Multiple users associated with the vendor and/or the customer, or both, can join and participate in a collaboration session. Guest passes can be provided to users by the discovery map tool program module 102 to provide secure access to a website displaying the visual map and/or a webpage associated with the collaborative session. By establishing a collaborative session between a vendor and a customer, the collection and organization of customer and vendor data addresses needs of the vendor's sales organization, such as managing the vendor-customer relationship.

At decision block 314, a determination is made whether information is confirmed. Typically, the customer interacts with the user via the online collaboration to confirm information contained in the visual map. Furthermore, underlying team information, issue information, and solution information can be confirmed by the customer or the vendor. The customer can provide feedback or changes to information via verbal, written, or electronic communication with the user or vendor. Any modifications or new information is received by the discovery map engine 204 and transmitted to the database engine 202 for storage in the database 126. The discovery map engine 204 updates the visual map as needed. If a customer confirms previously input information, then the “YES” branch is followed to 316 and the method 300 ends.

Confirmation of customer issue information leads to relatively efficient collection of information such as a customer's key business requirements. This type of information can then be used to position the vendor's products and services in a way that gains favorable customer mindshare.

If the customer does not confirm information, then changes to the previously input information are needed, and the “NO” branch is followed to 304, in which the system collects additional information as needed. The method 300 continues until all information is confirmed by the customer and a final visual map with customer-confirmed information is generated.

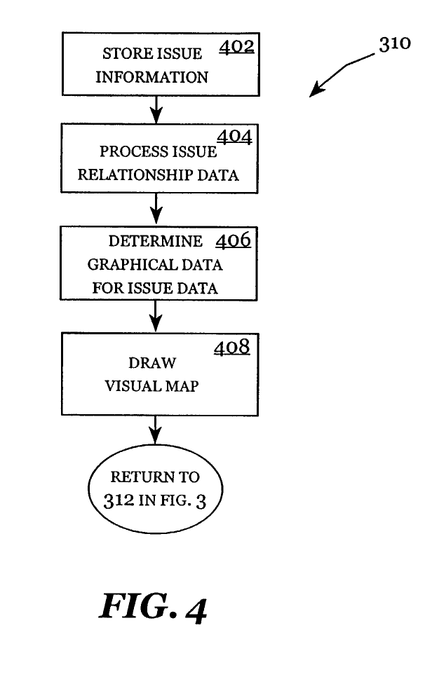

FIG. 4 illustrates a flowchart of subroutine 310 of the method shown in FIG. 3. The subroutine 310 details a sequence of how to generate a visual map according to an embodiment of the invention.

The subroutine begins at 402.

At 404, user-input issue information is stored. Typically, the discovery map engine 204 receives team information, issue information and solution information from one or more users for a particular collaboration session. The discovery map engine 204 transmits the information to the database engine 202 which stores at least the issue information in a database 126 or another data storage device for later retrieval.

At 406, issue relationship data is processed. Generally, issue information is stored in a record or file. For each issue, a related parent issue or subsequent issues may exist. The discovery map engine 204 processes each relationship or link between issues, and transmits this relationship information to the database engine 204 which stores the relationship information as issue relationship data within a corresponding record or file. For example, temporary tables can be stored in the database 126 or in an associated data storage device. The issue data or tree data for a particular customer can be stored in a first table. The tree data includes issues, parent issues, and issue/parent issue relationship data for the particular customer. A second table is organized to received the tree data in a hierarchical order. That is, for each issue and parent issue in the first table, a second table receives the relatively higher level parent issues. Next, the second table receives the relatively lower levels of issues until all of the data from the first table has been organized and processed into the second table.

At 408, graphical data for the issue data is determined. Typically, the discovery map engine 204 communicates with a related graphics application program to generate graphical data for the issue and relationship data provided in the second table. Graphical data can be stored by the database engine 204 in the database 126 or an associated data storage device.

After 408, the subroutine 310 returns to 312 of FIG. 3.

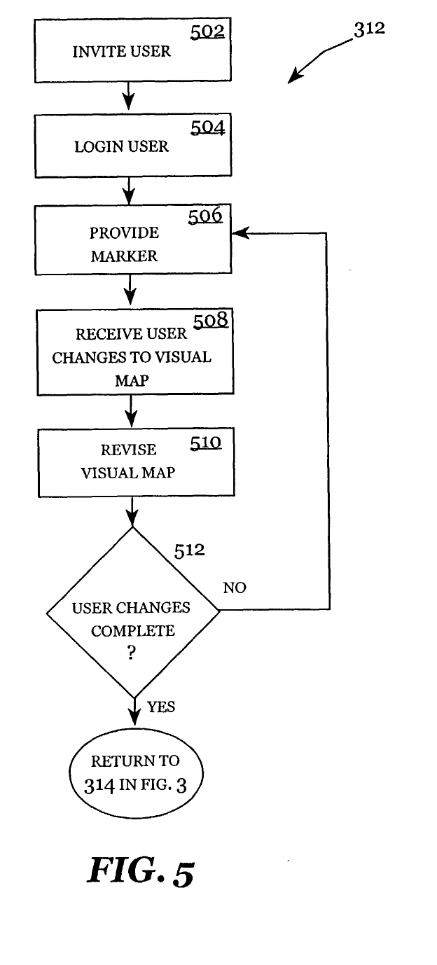

FIG. 5 illustrates a flowchart of a subroutine 312 of the method shown in FIG. 3. The subroutine 312 details a sequence of how to initiate a collaboration session between a vendor and a customer.

The subroutine begins at 502, in which a user is invited. The discovery map engine or the system administration engine 200 generates an invitation to one or more users to participate in a collaboration session. Typically, the user is associated with a customer, or can be persons associated with a vendor, or both. An invitation can be communicated via the network 108 as an electronic mail message, short messaging service message, or other communication via the network.

At 504, a user is logged in. When a user receives the invitation, the user can access a website hosted by the server. The discovery map engine 204 displays a collaboration session webpage including a view of the visual map. As each user logs in, each user's name is posted at the top of the webpage so that all the users that have logged in previously know the users that are participating in the current collaboration session.

In most cases, multiple users will be sent a guest pass by the discovery map engine 204 or the system administration engine 200 via e-mail or other means via the network 108. A guest pass can include a unique identification name associated with a password or code to gain access to a particular website associated with the collaboration session or a visual map for a particular team. However, a particular user may not be able to gain access to all information shown during a collaboration session such as competitive assessment webpages or political maps, and may be limited to visual maps showing issue and solution information.

At 506, a marker is provided. The discovery map engine 204 provides a marker on the webpage that can be used via an input device. Only the user designated as “with the marker” can use the marker on the webpage. If an alternate user desires to use the marker, the previously designated user can pass the marker to the alternate user, and the alternate user will be designated as “with the marker.” With the marker, a user can manipulate one or more objects displayed on the visual map. In this manner, users can edit, change, or otherwise confirm issue and relationship data contained within the visual map.

At 508, user changes to the visual map are received. Any changes designated by the marker, are received by the discovery map engine 204. Typically actions designated by the marker are tracked by the discovery map engine 204 and changes to the visual map are stored by the database engine in the database or associated data storage device. The discovery map engine 204 communicates any changes to an associated graphical application program.

At 510, the visual map is revised. Generally, the graphical application program or discovery map engine 204 revises the visual map with any user changes and the revised visual map is displayed.

At decision block 512, a determination is made whether all user changes are complete. Typically, the discovery map engine 204 receives corresponding user input if desired user changes are complete. If all changes are complete, then the “YES” branch is followed to 514, in which the subroutine goes back to 314 in FIG. 3.

If not all changes are complete, then the “NO” branch is followed to 506, in which the marker is provided to the users for additional user changes, and further changes can then be made to the visual map. The subroutine 312 continues in this manner until all user changes to the visual map are complete, and the subroutine goes back to 314 in FIG. 3.

In an exemplary set of webpages associated with the method 300, FIGS. 6-23 illustrate the generation of a visual map in accordance with various embodiments of the invention. FIGS. 6-23 include webpages displayed by a discovery map tool program module 102 to prompt a user in a “MentisWare Quick Start” procedure to set-up a team, to collaborate on generating one or more customer issues, to use templates, to extrapolate each issue to create an issue tree, and to convert the issue tree into a visual map such as a discovery map. Each of the Figures is described in turn below.

In FIG. 6, a webpage 600 displays an introductory display webpage to a user. The introductory display webpage 600 permits the user to manage and navigate through the functionality of the discovery map tool program module 102. In this webpage, a user can view recent collaborations 602, teams 604, and an individualized personal task list 606. The section labeled as recent collaborations 602 displays a list of status information for previous collaboration sessions that the user has participated in. Status information can include a unique name for the collaboration, a type of visual map that was generated, a team associated with the collaboration, and a date of last access.

Adjacent to 602, the section labeled as teams 604 displays status information for the user's association with a predefined team. Status information can include a unique team name and a date of creation.

Below 602 and 604, the section labeled as personal task list 606 displays status information for the user to confirm particular portions of information. Status information can include an indicator showing whether a task is complete, a unique task name, a person to whom a task is assigned, a due date, a team name associated with the task, and a delete button.

A list of user options 608 can also be shown on the left portion of the webpage 600 including options such as “Quicklinks”, “Resources”, “Set up a Team”, “Create a Collaboration”, “Manage a Customer List”, “My Profile”, and “Administration.” By selecting a user option such as “Set up a Team” 610, a user can proceed through a series of webpages provided by the discovery map tool program module 102 to enter data needed to generate a visual map for a collaboration session between a vendor and a customer.

A tabbed list of user options 612 across the top portion of the webpage 600, can include user options such as “Home”, “Select a Team”, “Templates” and “Log Out”. By selecting a user option such as “Select a Team” 610, a user can proceed through a series of webpages provided by the discovery map tool program module 102 to recall previously stored information such as pre-existing team information, and records of previously held collaboration sessions.

For example, the discovery map tool program module 102 can record various tasks that are associated with collecting, gathering, or confirming information for a particular customer. The personal task list 606 can be used to track the progress made by one or more persons associated with a vendor in collecting, gathering, or confirming information needed to begin addressing various needs of the vendor and customer.

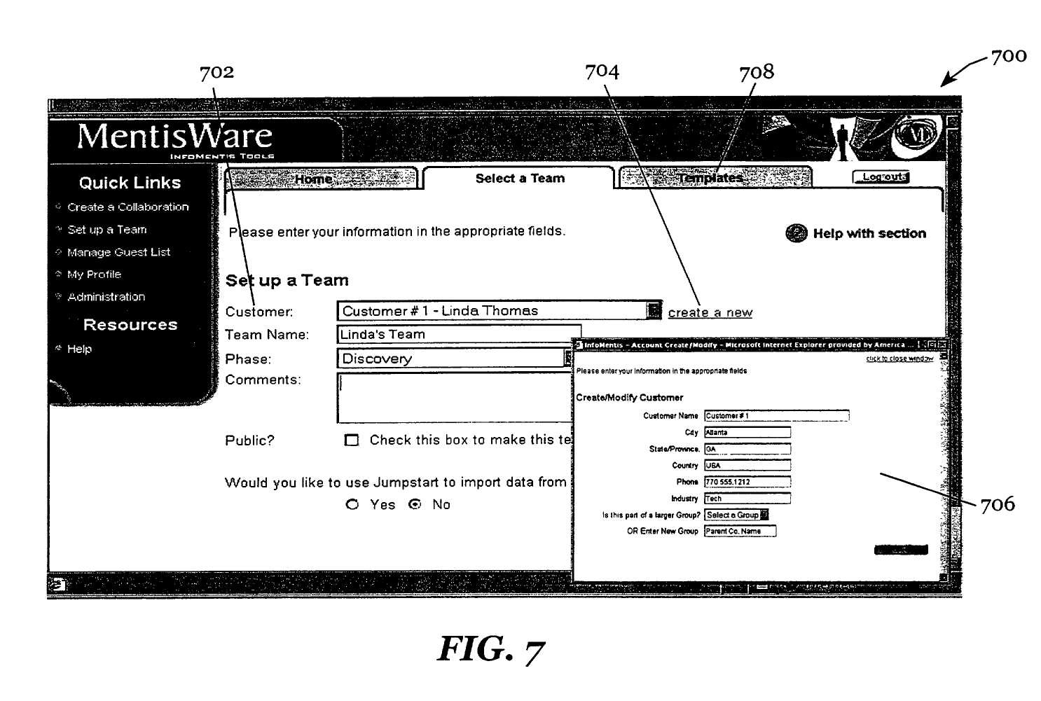

In FIGS. 7-11, a series of webpages associated with collecting team information are illustrated. In FIG. 7, a webpage 700 displays a series of queries associated with the user option in FIG. 6 labeled as “Set up a Team” 610. Queries 702 to a user to input specific team information such as a customer name, team name, project phase, and comments can be displayed adjacent to or within a series of fields, pulldown boxes, radio buttons, checkboxes, or other recognized user input features designed to prompt user input in response to a query. Each team associated with a vendor should be associated with at least one prospective or existing customer. For example, to enter customer information, a prompt to

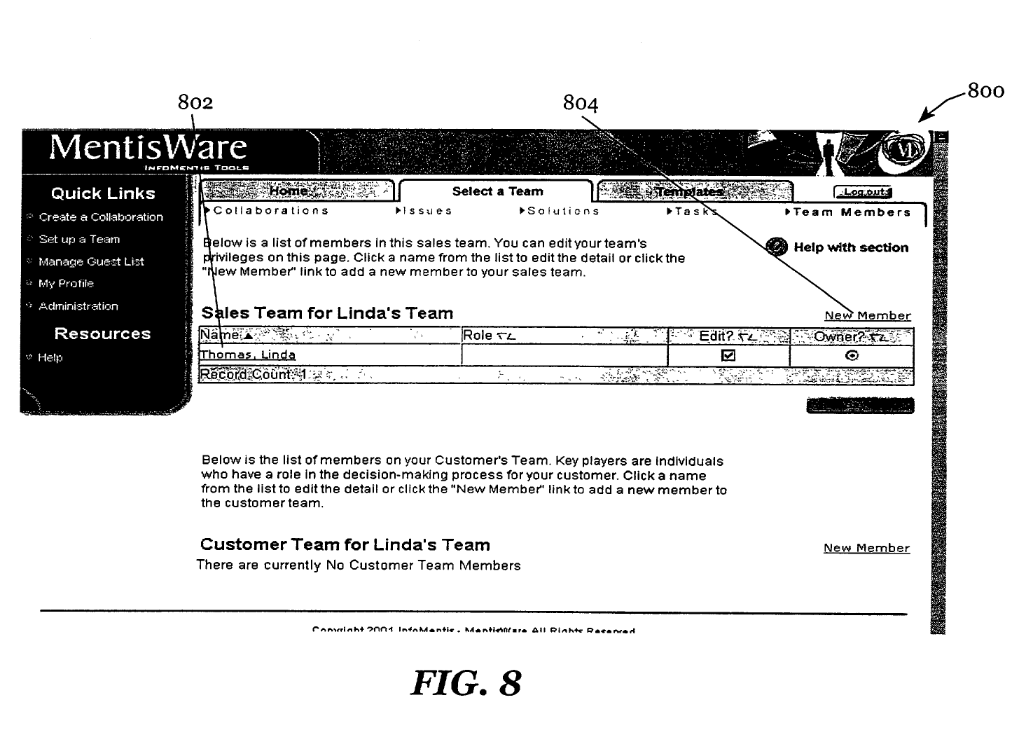

“Create a New” 704 can be displayed. When the prompt is selected, the discovery map tool program module 102 creates a pop-up window 706 to further prompt a user to edit, delete, or add information associated with a particular customer. After information associated with the customer is input, the discovery map tool program module 102 stores the information in a database 128 and the pop-up window 706 is closed. In some instances, an associated prompt in the webpage 700 or pop-up window 706 may be provided for the user to call upon a pre-existing template of information that has been previously collected or stored for a particular industry, industry segment, or marketplace group. Templates may be accessible via the template tab 708. After the user has input customer information to be associated with a sales team, the discovery map tool program module 102 can prompt the user for information associated with the sales team as shown in FIG. 8.

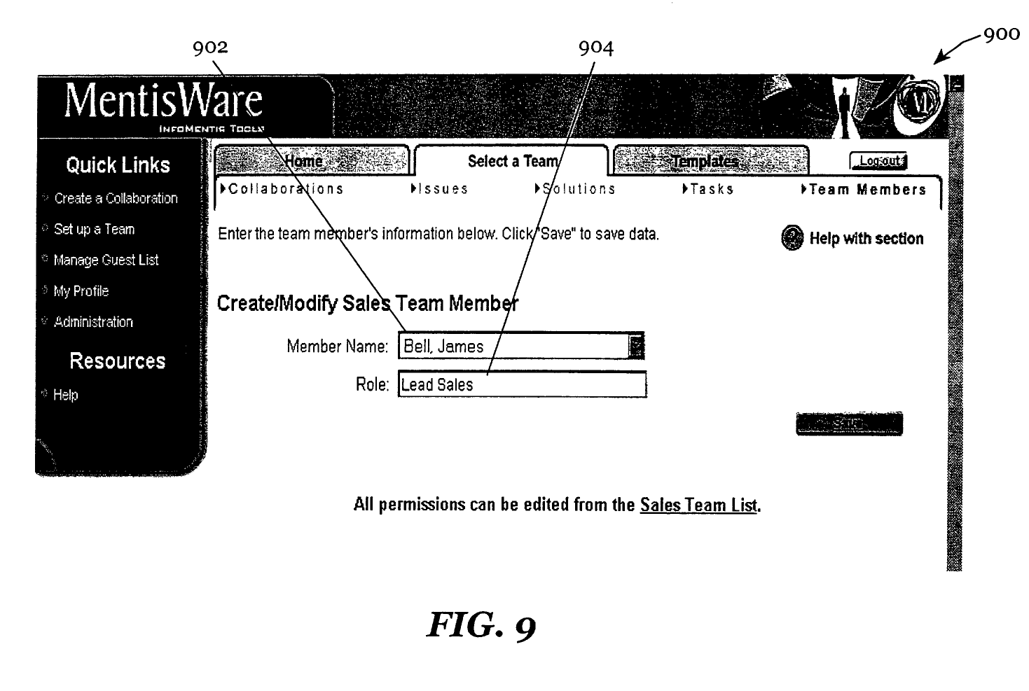

In FIG. 8, a webpage 800 displays status information for previously identified sales team members 802 is shown adjacent to a prompt to add “New members” 804. When the prompt labeled as “New members” 804 is selected, a series of webpages shown in FIGS. 9-11 collects team information associated with a customer.

In FIG. 9, a webpage 900 prompts a user to input team information such as team member name 902 and the team member's role 904 with respect to the customer, such as “Lead Sales.” After team information is input into the webpage 900, the discovery map tool program module 102 stores the team information, and continues to a webpage 1000 in FIG. 10 to display any updated or new team information.

In FIG. 10, the webpage 1000 displays updated or new team information for all currently entered team members 1002 associated with a particular customer. On this webpage 1000, a user can view the team member name, role, whether the team member can edit team information in a collaboration session, and whether a particular team member is an “owner.” A user has the option of permitting selected team members to edit previously input team information such as the particular team member's information. Furthermore, a user can also designate specific team members as an “owner.” For example, an “edit” box 1004 is useful during a collaboration session. By checking the edit box on the webpage 1000, a corresponding team member can edit his or her own team information during the collaboration session. If a user desires to edit a particular team member's information, the user can click directly on a team member's name in 1002. Otherwise, if the user desires to add a team member, the user clicks on the new member prompt 1006 to continue to a webpage shown in FIG. 11.

FIG. 11 illustrates a webpage 1100 for identifying or designating particular attributes of a team member, such as role of the team member, attributes or characteristics of the team member, and to further identify whether the team member is a “key player.” The webpage 1100 provides queries 1102 for a team member's name, role, attributes, and whether the team member is a “key player.” Associated fields 1104, pulldown boxes, radio buttons, checkboxes, or other recognized user input features receive user input in response to the queries 1102. A “key player” is defined as a team member having a relatively strong or powerful influence over the decision making associated with a resolution of an issue. Attributes or characteristics of a team member include descriptions of a person's personality, style, interests, interaction with others, or other observations about a person's behavior. Usually, attributes or characteristics of a team member assist a person in understanding the team member's role, responsibility, or personality within their respective organization.

When the user has completed input of team information in the webpage 1100, the team information is stored by the database engine 206 in a database 126. The user continues to enter team information for team members until all team members are accounted for. Using similar webpages to 1100, the user can then enter team information input for a customer team associated with the sales team. Team information for a customer team can include a customer team member name, a role of the team member, attributes or characteristics of the team member, and whether the customer team member is a “key player.” When the user has completed entering relevant team information, the user can continue by checking the status of teams in a webpage shown in FIG. 12.

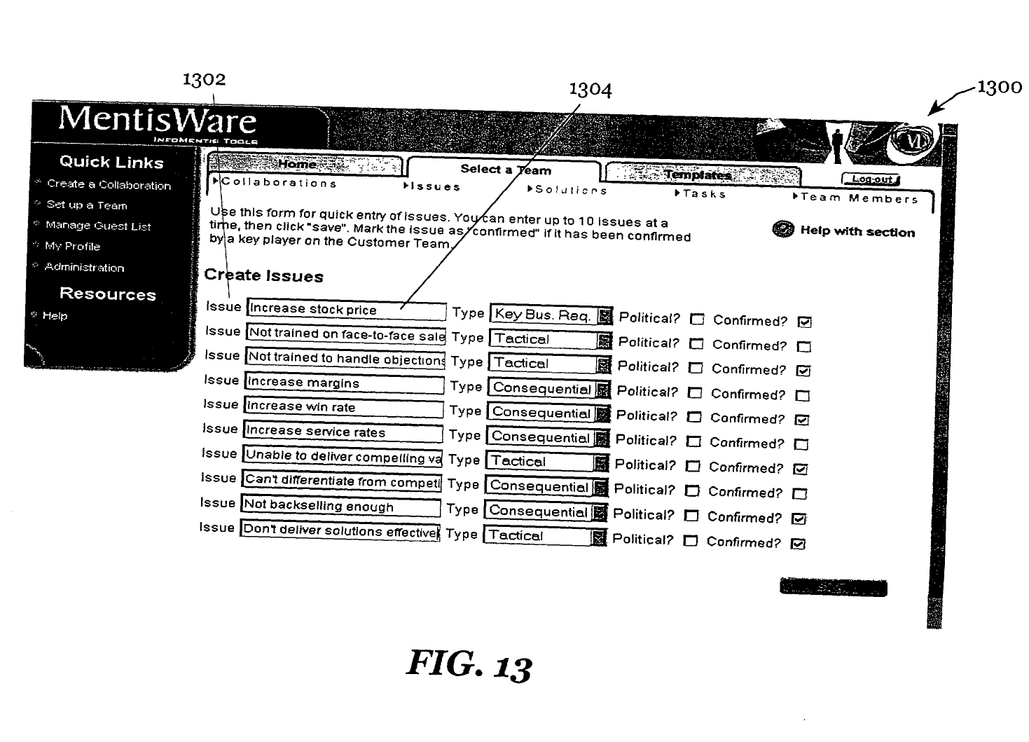

FIG. 12 illustrates a webpage 1200 showing the status of one or more sales teams 1202 and associated customer teams 1204 for a particular user. The user can select a team member from a sales team 1202 or customer team 1204 to review and, if needed, further edit a particular team member's attributes, roles, or other characteristics, using similar webpage features as previously described. As described above, after the user has completed entering team information, the database engine 206 stores the collected information in the database 128 for later retrieval. When the user has completed input for at least one sales team and one associated customer team, the user can continue to a webpage shown in FIG. 13.

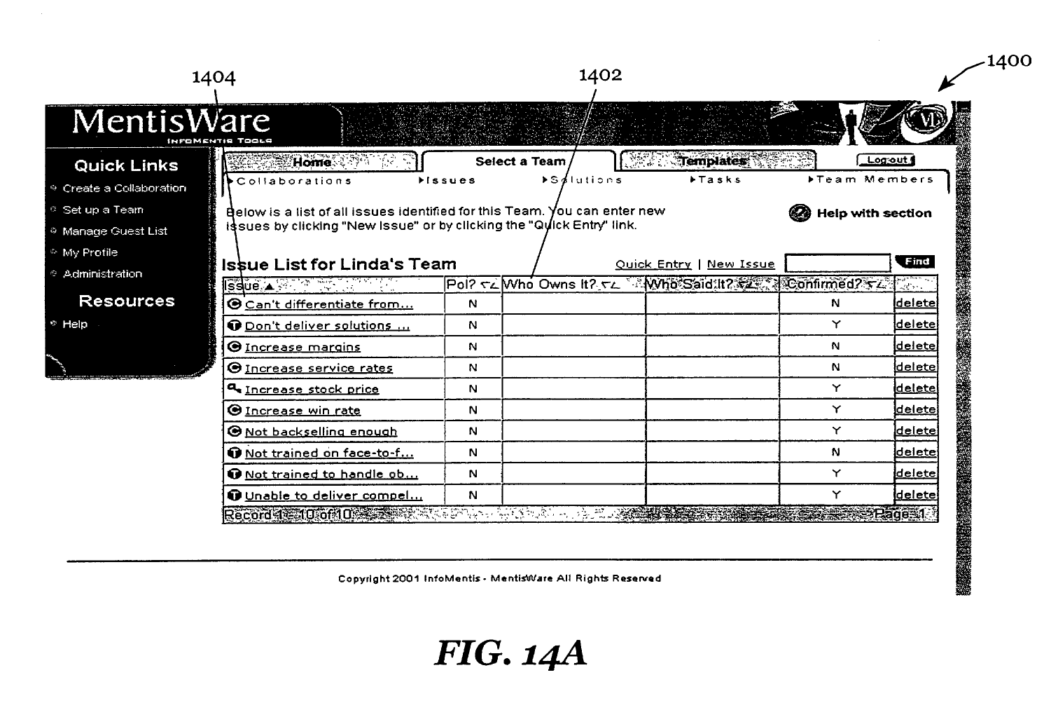

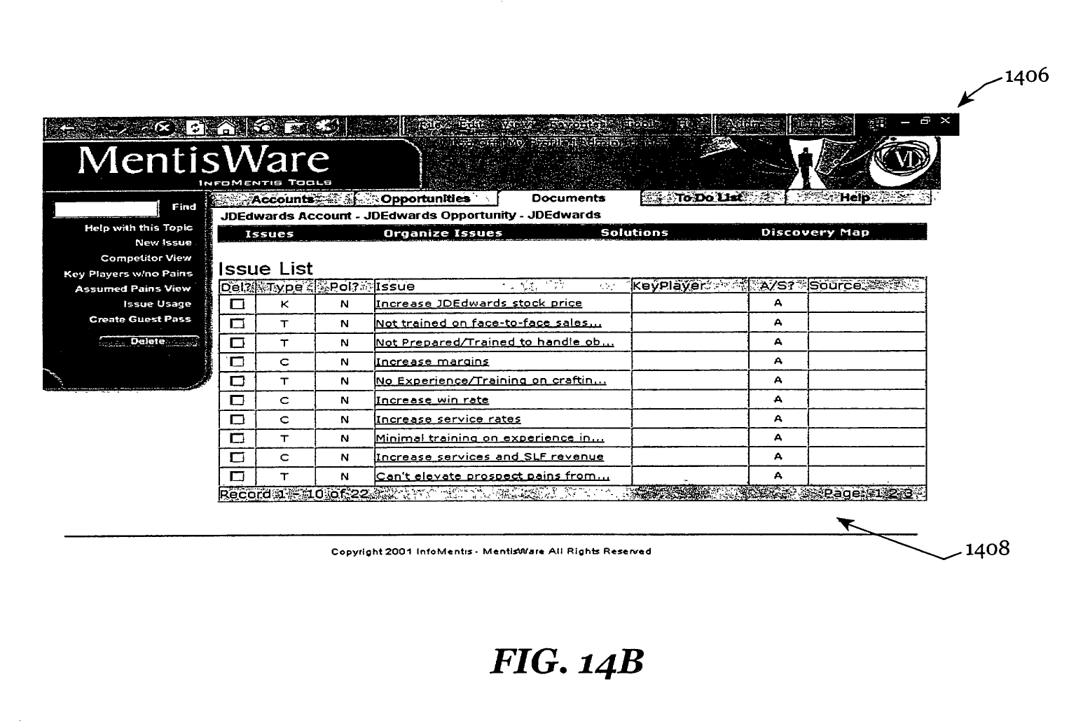

In FIG. 13, a webpage 1300 provides prompts 1302 for a user to input issue information associated with a particular customer. Typically, a sales team desires to address a customer's issues, and each of the customer issues can be input into the webpage 1300 by a user or vendor personnel. The discovery map tool program module 102 provides fields 1304 to collect issue information from a user. Issue information that can be collected includes a description of an issue, an issue type, i.e. key business requirement, tactical pain or consequential pain, whether the issue is “political” and whether the issue is confirmed by a customer. When the user has completed entry of issue information into the webpage 1300, the database engine 206 stores the issue information in the database 128 for later retrieval. The discovery map tool program module 102 provides a status update of issue information for the user to view as shown in FIGS. 14A and 14B.

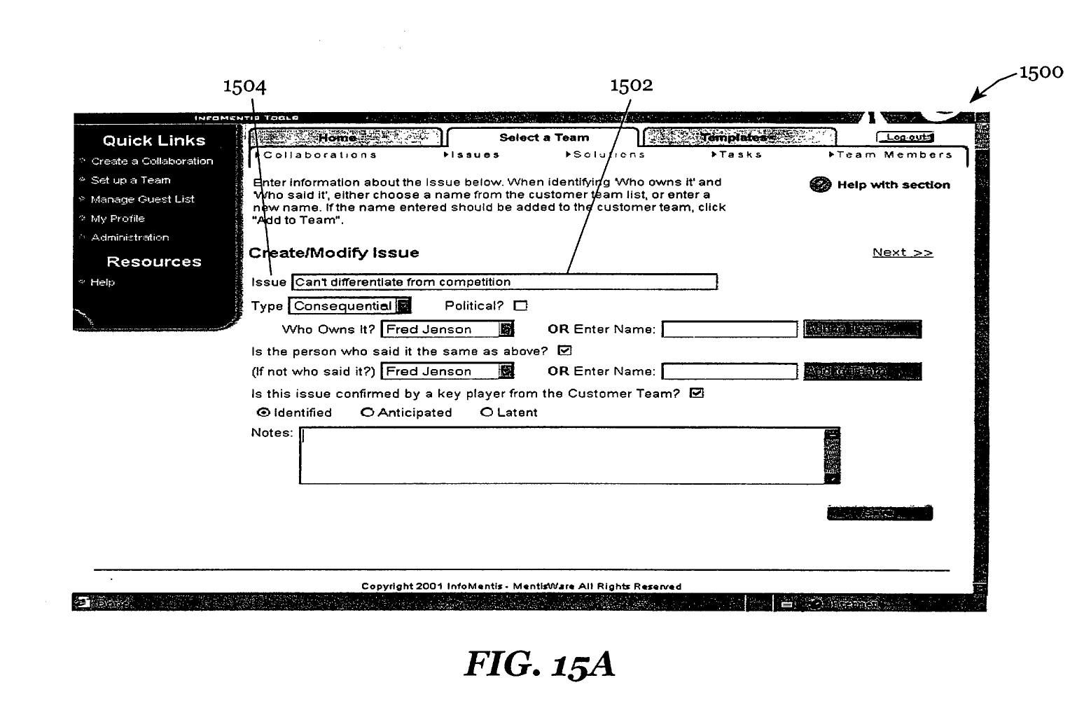

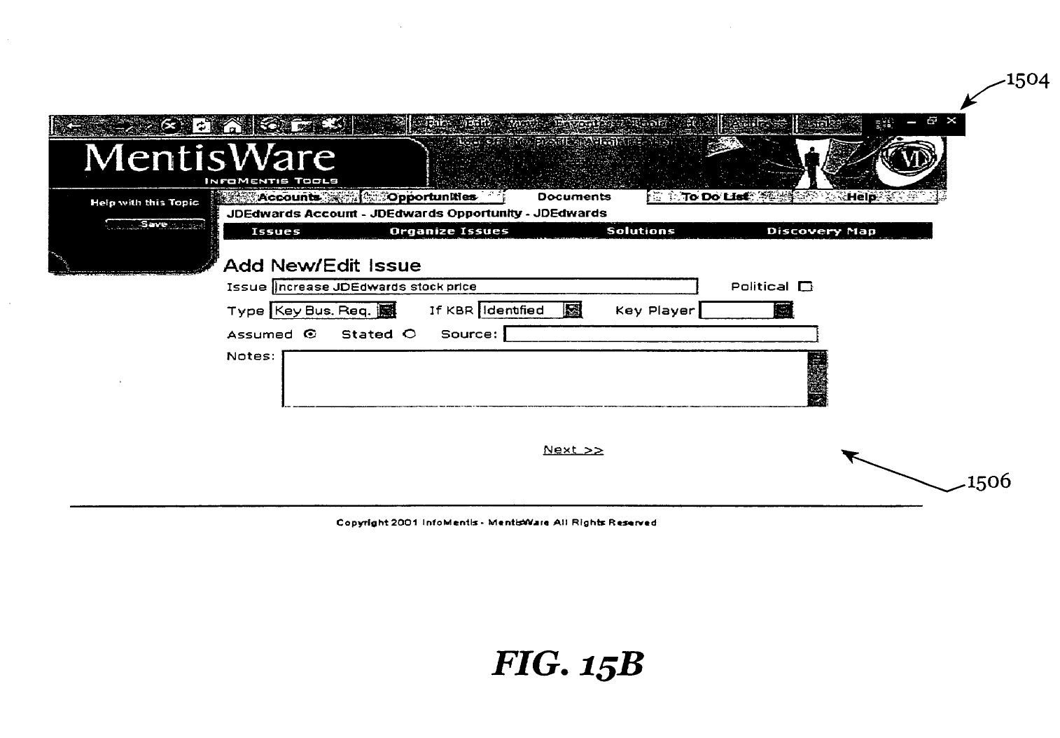

In FIG. 14A, a webpage 1400 displays a status field 1402 for each previously input issue 1404 or otherwise previously collected by the discovery map tool program module 102. The status field 1402 can include issue information such as the name of the issue, whether an issue is “political”, who owns the issue, who said it, whether the issue is confirmed. If a user desires to change or modify issue information, the user can use an input device to click on a particular issue 1404 to change or modify issue information associated with the issue. Changes to issue information can be made in webpages similar to FIGS. 13 and 15A-B. When the user has completed entry of issue information into the webpage 1400, the database engine 206 stores the issue information in the database 128 for later retrieval.

Another webpage to view previously collected issue information is shown in FIG. 14B. The webpage 1406 in FIG. 14B also includes a status field 1408 containing issue information such as the name of the issue, whether an issue is “political”, who the key player(s) is/are, source of the issue, and whether the issue is assumed (A) or stated (S). When the user has completed entry of issue information into the webpage 1406, the database engine 206 stores the issue information in the database 128 for later retrieval.

As shown in FIG. 15A, a webpage 1500 for input of additional issue information is provided by the discovery map tool program module 102. Additional issue information for each issue can be input by the user into a series of input fields 1502 or combination of pulldown boxes, radio buttons, or other devices or features. For example, the webpage 1500 utilizes a series of queries 1504 to prompt a user for additional issue information such as description of an issue, issue type, who owns the issue, who is the person that identified the issue, whether an issue has been confirmed by the customer, or notes about the issue. The queries 1504 assist the user in “drilling” down each issue to determine relevant customer issue information. When the user has completed input of issue information, the received information is stored by the database engine 206 in the database 128 for later retrieval.

Another webpage to view edit, modify or change issue information is shown in FIG. 15B. The webpage 1504 in FIG. 15B also includes a series of input fields 1506 or combination of pulldown boxes, radio buttons, or other devices or features. Similar to the webpage 1500 in FIG. 15A, the webpage 1504 can query a user for additional issue information such as description of an issue, issue type, if the issue is a key business requirement, key player associated with the issue, whether the issue is stated or assumed, source of the issue. When the user has completed entry of issue information into the webpage 1504, the database engine 206 stores the issue information in the database 128 for later retrieval. After issue information has been input by a user, a user continues to a webpage shown in FIG. 16A or 16B.

FIG. 16A illustrates a webpage 1600 displaying solution information for a particular issue or customer. The webpage 1600 provides a user selection option such as “New Solution” 1602 to input new or additional solution information. The user may also select from user options 1604 such as review collaborations, issues, tasks, team members, or other previously input, collected, or gathered information. In another instance, if previously input solution information exists, the solution information can be displayed on the webpage 1600. When the user has completed entry of issue information into the webpage 1600, the database engine 206 stores the issue information in the database 128 for later retrieval.

Another webpage 1606 to view solution information is shown in FIG. 16B. Solution information in a series of data fields 1608 includes the type of solution as defined by a preselected category, and the solution name. When the user has completed entry of issue information into the webpage 1606, the database engine 206 stores the issue information in the database 128 for later retrieval. In either or both FIG. 16A and 16B, a user can view solution information and decide to create or modify solution information in another webpage as shown in FIG. 17.

A webpage 1700 as shown in FIG. 17 provides a series of queries 1702 for solution information, and associated fields 1704 to enter new or modified solution information, such as a description of a solution, a solution component, and notes about a solution. After solution information has been input by the user for a corresponding issue into the webpage 1700, the database engine 206 stores the issue information in the database 128 for later retrieval. The user can then continue and initiate a collaboration session as shown in FIG. 18.

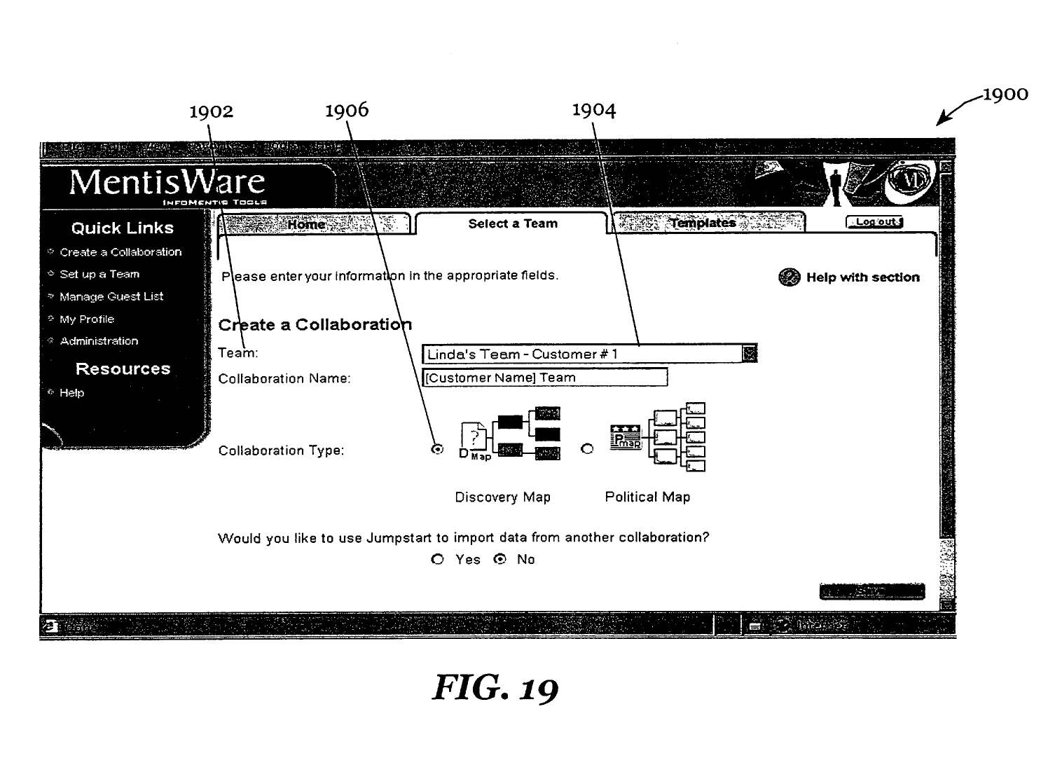

In FIG. 18, a webpage 1800 for initiating or otherwise displaying a collaboration list is shown. A collaboration list displays status information for each collaboration session that a user on a particular sales team has participated in or otherwise initiated via the discovery map tool program module 102. Status information is useful to track events in a particular collaboration session. If there is one or multiple collaboration sessions that the user has participated in or otherwise initiated, the webpage 1800 can show the name of each collaboration session and links to a webpage for each collaboration session in a collaboration list portion 1802. If there are no collaboration sessions associated with the user, the user can create a new collaboration session by linking to a webpage as shown in FIG. 19 via a button or link 1804 labeled “New Collaboration.”

In FIG. 19, a webpage 1900 provides queries 1902 and associated input fields 1904 to prompt user input of unique information to identify a new collaboration session. Unique information to identify a new collaboration session can include a team name associated with the new collaboration, a collaboration session name, a type of visual map to be generated for the collaboration session, and whether additional data should be imported from another collaboration session. The discovery map engine 204 can generate a variety of visual maps such as a discovery map, an issue tree, a political map, or any other visual representation that includes a combination of at least some of the following: team information, issue information, and solution information. The user can designate the type of visual map to be generated via a radio button 1906 or other input device. When the user has completed entry of information to identify a new collaboration session, the database engine 206 stores the information in the database 126 for later retrieval.

A collaboration session allows a vendor and customer to communicate via the network 108, and to provide greater understanding of the customer's business issues and the potential solutions to address the issues. During the collaboration session, the vendor can show the customer various findings via the visual map, and the customer can verify, correct, add, or modify information. After the new collaboration session has been identified, the discovery map tool program module 102 proceeds to another webpage to receive user input for generating a visual map for the collaboration session. A series of templates including previously encountered problems faced by customers in a given industry can also be provided in conjunction with the visual map.

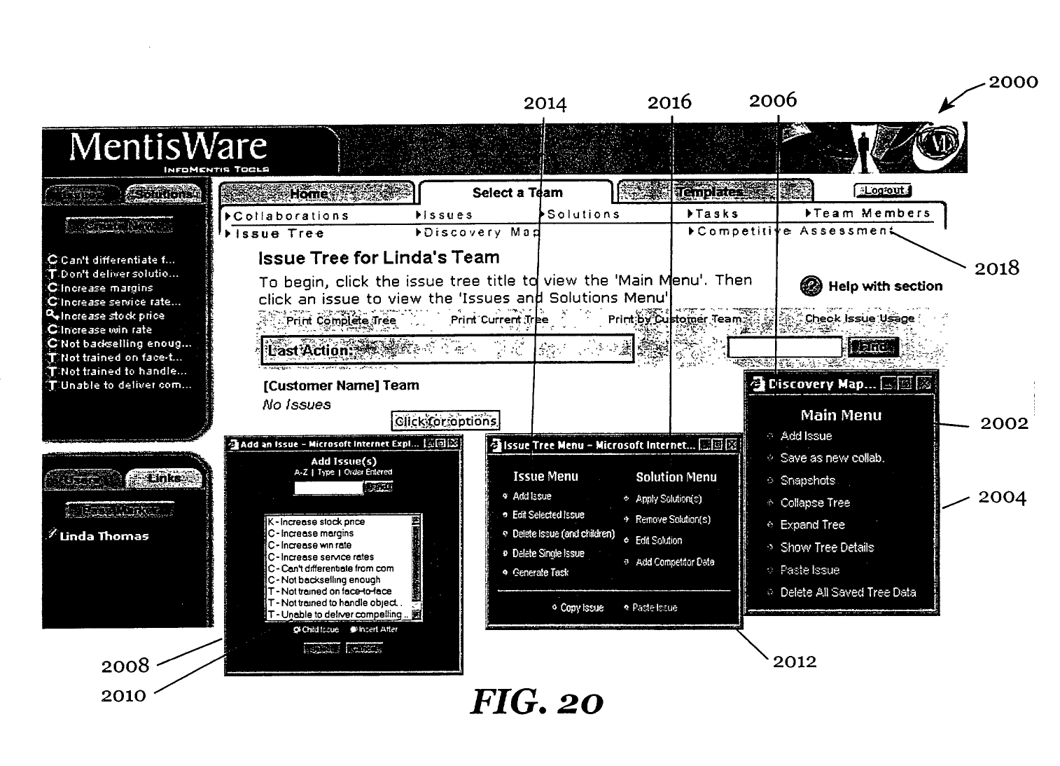

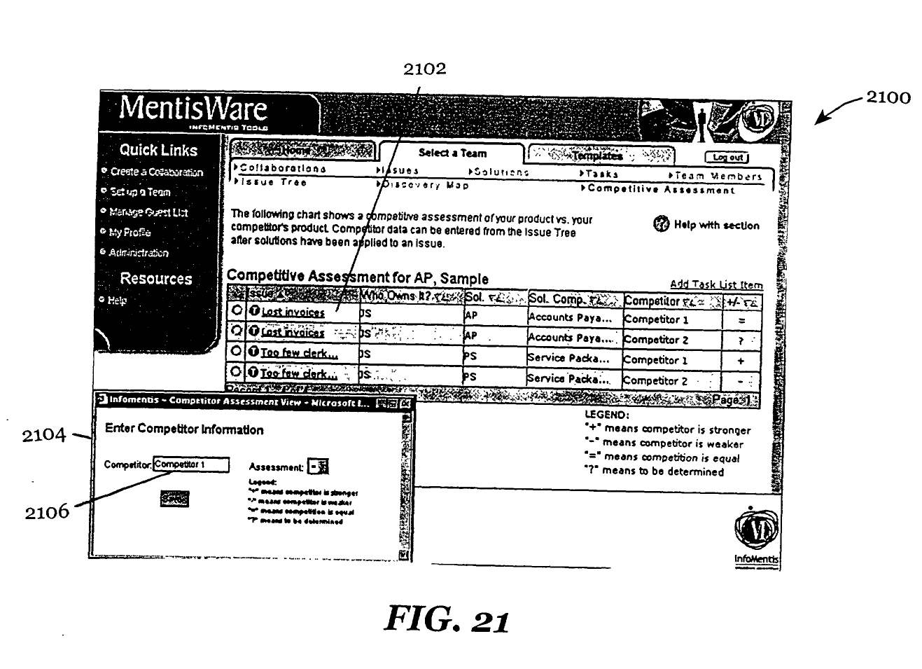

FIG. 20 shows a webpage 2000 to receive user input for generating a visual map such as an issue tree for a collaboration session. A menu 2002 of user options such as “Add Issue”, “Save as New Collaboration”, “Snapshots”, “Collapse Tree”, “Expand Tree”, “Show Tree Details”, “Paste Issue”, and “Delete All Saved Tree Data” can be displayed in a pop-up window 2004 associated with the webpage 2000. Typically, the user builds a visual map such as an issue tree by clicking on the user option 2006 labeled “Add Issue.” Another pop-up window 2008 displays a list 2010 of issues associated with previously input issue information. The user may select one or more issues from the list 2010 for the visual map. As the user selects an issue, the discovery map engine 206 begins generating a visual map. Yet another pop-up window 2012 displays additional user options such as “Copy Issue” and “Paste Issue” as well as menus of other user options labeled as “Issue menu” 2014 and “Solution menu” 2016. User options in an “Issue menu” 2014 can include “Add Issue”, “Edit Selected Issue”, “Delete Issue (and children)”, “Delete Single Issue”, and “Generate Task”. Further, user options in a “Solution menu” 2016 can include “Apply Solution(s)”, “Remove Solution(s)', “Edit Solution”, and “Add Competitor Data”. Generally, the user adds and organizes issues for the visual map, and then applies solution information such as competitive information to each issue. A link 2018 to “Competitive Assessment” leads the user to a webpage shown in FIG. 21 for entering competitor information.

A webpage 2100 for displaying the status of new or previously entered competitive solution information is shown in FIG. 21. Competitive information for one or more issues can be entered by the user into a series of fields similar to those shown in previously described webpages. The status field 2102 on the webpage 2100 shows issue information, who owns it, solution type, solution component, competitor identity, and a relative ranking of competitor strength. A user viewing this type of information can evaluate strengths and weaknesses for particular solutions to various issues. A pop-window 2104 can provide a data entry field 2106 to enter new or modified solution information for the status field. As new or modified solution information is entered into the data entry field, the information is stored by the database engine 206 in the database 126, and the status field 2102 is updated by the discovery map engine 204 for subsequent display to the user on the webpage 2100.

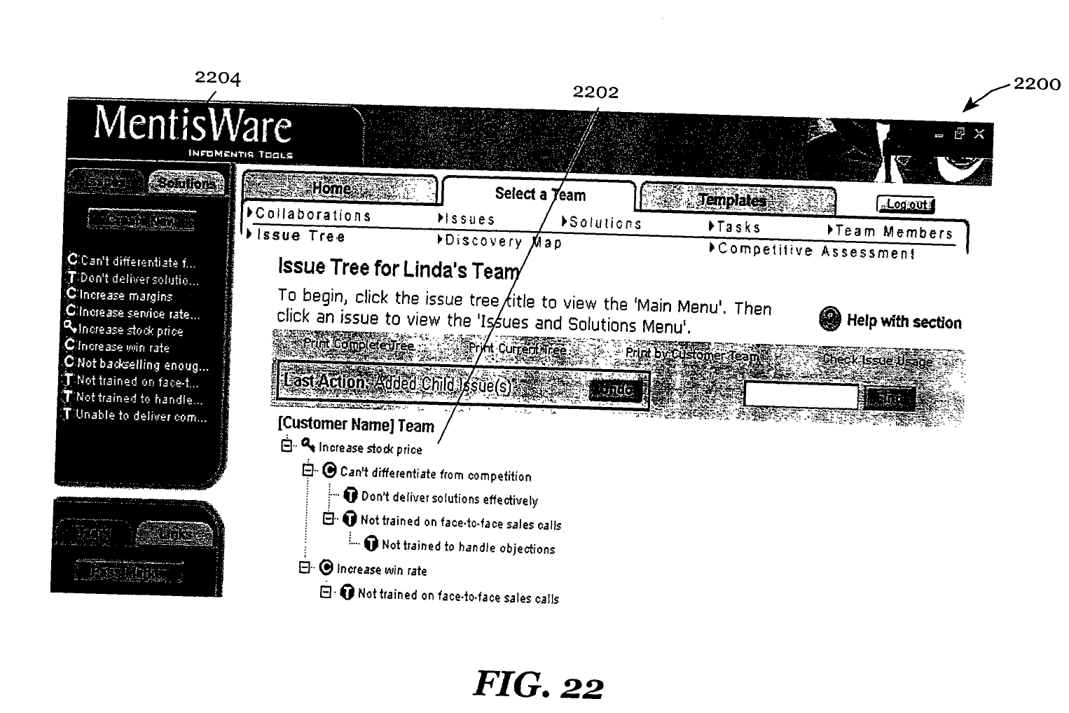

When the user has completed entry of competitive solution information, the user can return to selects issue and solution information for the visual map as shown in FIG. 20. The discovery map engine 206 generates the visual map for simultaneous display on another webpage as shown in FIG. 22.

FIG. 22 illustrates a webpage 2200 for displaying a generated visual map 2202. The visual map 2202 displays selected issue and solution information for a particular team associated with the user. As the visual map 2202 is displayed on the webpage 2200, the webpage 2200 can be made available by the discovery map engine 206 for viewing by preselected users via the network 108 in a collaboration session. A menu 2204 displayed for user selection can provide user access to issue and solution information. An associated menu (not shown) can include user options for printing a visual map such as “Print Complete Tree”, “Print Current Tree”, “Print by Customer Team”, and “Check Issue Usage.” When the user is ready to discuss the visual map 2202 in a collaboration session, the user can store the visual map 2202 for later retrieval and use.

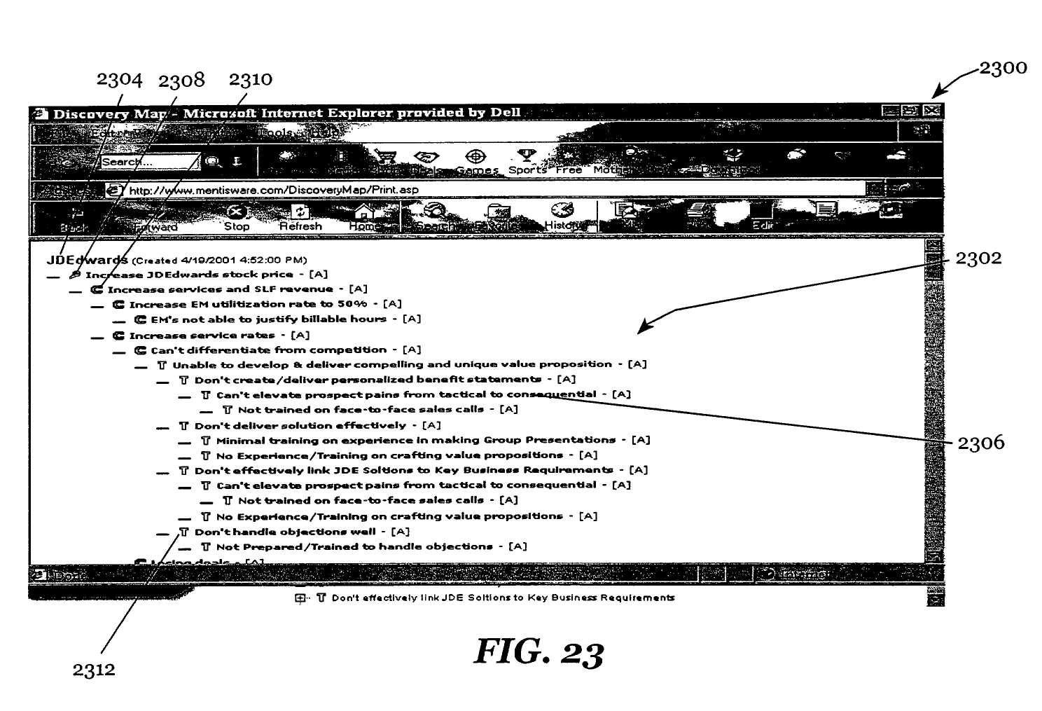

FIGS. 23-25 illustrate webpages showing various types of visual maps. A visual map provides a graphical or visual representation of the business challenges and goals for a particular customer's organization. FIG. 23 shows a webpage 2300 with a visual map 2302 such as an issue tree initially organized by a user. Previously input team information for a team 2304 such as “J. D. Edwards Account” is obtained from the database 128 by the discovery map tool program module 102. Issue information 2306 can be displayed in a format such as a visual map 2302 or issue tree designed for viewing issue and solution information together. In the visual map 2302, issue information is typically displayed in a hierarchical order beginning with relatively higher level issues such as key business requirements designated with a unique symbol such as a key shape 2308. Relatively lower level issues such as consequential pains and tactical pains associated with key business requirements are assigned to each higher level issue, and displayed as a C-shape 2310 and T-shape 2312 respectively. For example, the hierarchical relationships illustrated in the webpage 2300 include parent-child relationships between several key business requirements and their respective tactical and consequential pains.

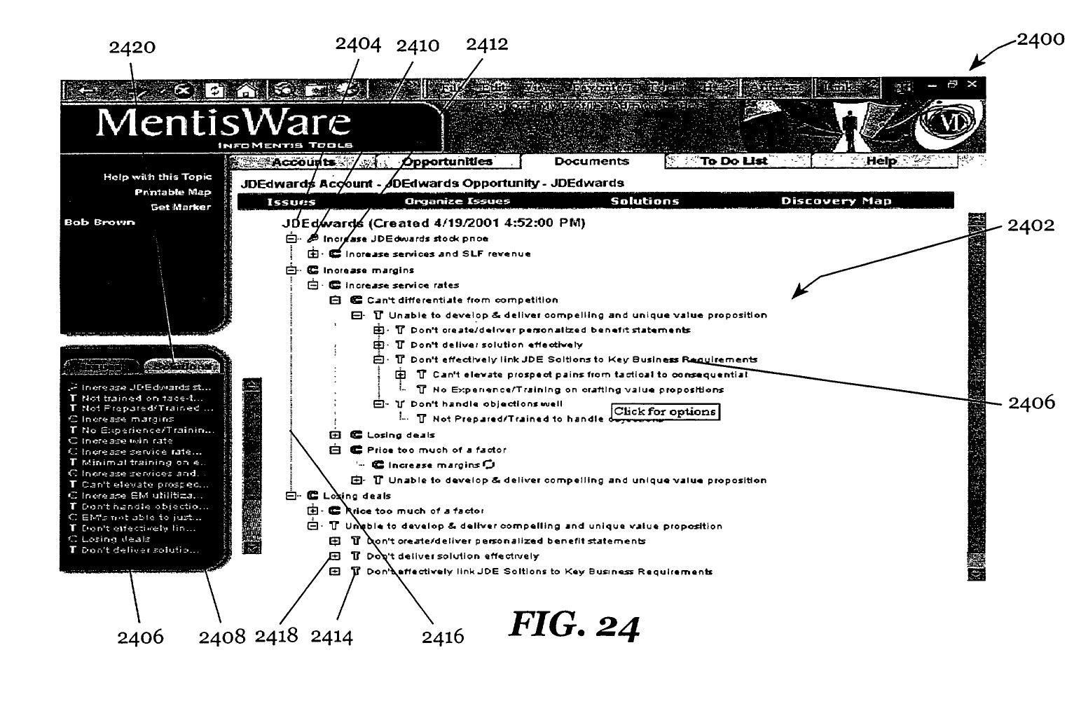

In FIG. 24, a webpage 2400 displays a visual map 2402 such as an issue tree including issue and solution information for a particular team. Previously input team information for a team 2404 such as “J. D. Edwards Account” is obtained from the database 128 by the discovery map tool program module 102. Issue information 2406 can be displayed in a format such as a visual map 2402 or issue tree designed for viewing issue and solution information together, or tabulated in a list 2408 for user viewing and access of each issue. In the visual map 2402, issue information is typically displayed in a hierarchical order beginning with relatively higher level issues such as key business requirements designated with a unique symbol such as a key shape 2410. Relatively lower level issues such as consequential pains and tactical pains associated with key business requirements are assigned to each higher level issue, and displayed as a C-shape 2412 and T-shape 2414 respectively. Guidelines 2416 indicating relationships between respective issues are drawn to provide a user with a visual indicator of a relationship between issues. As a user navigates through the visual map 2402, the user can collapse or expand various branches of the issue tree by clicking on the input boxes 2418 adjacent to the issue symbols 2410-2414. Associated solution information for each issue can be obtained by clicking the “Solution” tab 2420 of the list 2408.

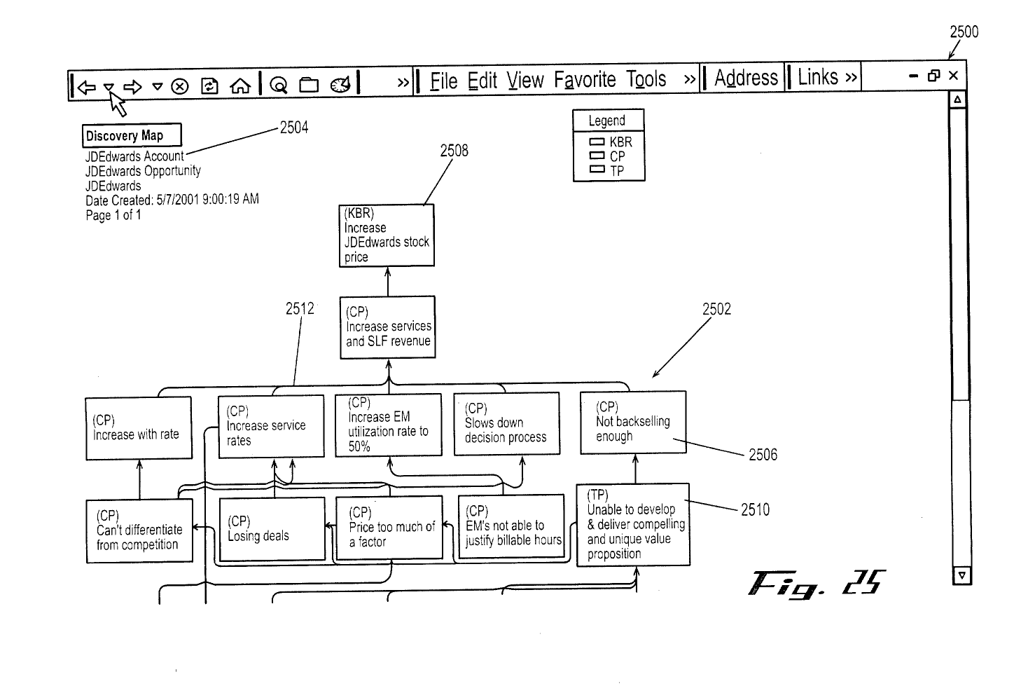

In FIG. 25, a webpage 2500 displays a visual map 2502 such as an issue flowchart including issue and solution information for a particular team. Previously input team information for a team 2504 such as “J. D. Edwards Account” is obtained from the database 128 by the discovery map tool program module 102. Issue information 2506 can be displayed in a format such as a visual map 2502 or issue flowchart designed for viewing issue and solution information together. In the visual map 2502, issue information 2506 is typically displayed in a hierarchical order beginning with relatively higher level issues such as key business requirements identified in a box 2508 located near the top portion of the visual map 2502 or issue flowchart. Relatively lower level issues such as consequential pains and tactical pains associated with key business requirements are assigned to each higher level issue, and displayed in boxes 2510 located beneath the box 2508 containing relatively higher level issues such as key business requirements. Guidelines 2512 indicating relationships between respective issues are drawn to provide a user with a visual indicator of a relationship between issues.

The invention we claim is:

1. A method for managing interactions between a vendor and a customer, comprising:
receiving team information associated with the vendor and the customer;
receiving issue information associated with the customer;
receiving solution information associated with the vendor;
generating a visual map incorporating the team information, issue information, and solution information;
initiating an on-line, real time collaboration session between the vendor and the customer; and
confirming the team information, issue information, and solution information with the customer.

2. The method of claim 1, wherein generating a visual map incorporating the team information, issue information, and solution information comprises:
storing the issue information including issue relationship data;
processing the issue relationship data;
determining graphical data for the issue relationship data; and
displaying a visual map using the graphical data and the issue information.

3. The method of claim 2, wherein displaying a visual map using the graphical data and the issue information occurs via a network.

4. The method of claim 1, wherein initiating an on-line, real time collaboration session between the vendor and the customer occurs via a network.

5. The method of claim 1, wherein initiating an on-line, real time collaboration session between the vendor and the customer, comprises:
inviting a customer to participate in a collaboration session;
logging in the customer to the collaboration session;
providing a marker to the vendor and the customer;
receiving changes to the visual map via the marker; and
revising the visual map in accordance with the changes.

6. The method of claim 1, wherein the team information includes at least some of the following: customer or prospect name, team name, individual names, individual roles, or individual attributes.

7. The method of claim 1, wherein the issue information includes at least some of the following: a subject associated with a customer, a type or characteristic of an issue, rating of an issue, a person involved with a specific issue, ownership of an issue, whether an issue is stated or assumed, confirmation of an issue, or a prioritization of a list of issues.

8. The method of claim 1, wherein the solution information includes at least some of the following: an action to address or otherwise solve a previously input issue, competitive information, or a solution component.

9. The method of claim 1, wherein generating a visual map incorporating the team information, issue information, and solution information, further comprises:

10. The method of claim 1, wherein initiating an on-line, real time collaboration session between the vendor and the customer occurs via a network.

11. A system for managing a customer relationship via a network, comprising:
a discovery map tool program module including:
a discovery map engine in communication with the network, the discovery map engine adapted to:
receive team information associated with the vendor and the customer;
receive issue information associated with the customer;
receive solution information associated with the vendor;
a database engine in communication with the discovery map tool program module, the database engine adapted to:
store the team information, issue information, and solution information;
wherein the discovery map engine is further adapted to:
generate a visual map incorporating the team information, issue information, and solution information;
initiate an on-line, real time collaboration session between the vendor and the customer; and
confirm the team information, issue information, and solution information with the customer.

12. The system of claim 11, further comprising:
a system administration engine adapted to:
login a vendor or a customer to a collaboration session.

13. The system of claim 11, wherein the discovery map engine is further adapted to:
invite a customer to participate in a collaboration session;
provide a marker to the vendor and the customer;
receive changes to the visual map via the marker; and
revise the visual map in accordance with the changes.

14. The system of claim 13, wherein the discovery map engine is in communication with a graphics application program.

15. The system of claim 11, wherein the network is the Internet.

16. A method for using a network to determine a customer's business-related need, comprising:
receiving team information associated with the vendor and the customer;
receiving issue information associated with the customer;
receiving solution information associated with the vendor;
storing the team information, issue information, and solution information in a database;
displaying a visual map via the network, the visual map incorporating the team information, issue information, and solution information;
collaborating on-line and in real time with a customer via the network; and
receiving customer confirmation via the network of at least some of the team information, issue information, and solution information.

17. The method of claim 16, wherein the network is the Internet.

18. The method of claim 16, wherein the team information includes at least some of the following: customer or prospect name, team name, individual names, individual roles, or individual attributes.

19. The method of claim 16, wherein the issue information includes at least some of the following: a subject associated with a customer, a type or characteristic of an issue, rating of an issue, a person involved with a specific issue, ownership of an issue, whether an issue is stated or assumed, confirmation of an issue, or a prioritization of a list of issues.

20. The method of claim 16, wherein the solution information includes at least some of the following: an action to address or otherwise solve a previously input issue, competitive information, or a solution component.
